(19) United States
(12) Patent Application Publication
(10) Pub. No.: US 2026/0140492 A1
(43) Pub. Date: May 21, 2026

(54) FACETED MATERIAL AND METHOD FOR FABRICATING THEREOF

(71) Applicant: Foldstar, Inc., Hamilton, NJ (US)

(72) Inventors: Daniel KLING, Newtown, PA (US); Connor Healy, Lambertville, NJ (US)

(73) Assignee: Foldstar, Inc., Hamilton, NJ (US)

(21) Appl. No.: 19/393,117

(22) Filed: Nov. 18, 2025

Related U.S. Application Data
(60) Provisional application No. 63/723,456, filed on Nov. 21, 2024.

(51) Int. Cl. G05B 19/4093

(52) U.S. Cl. CPC G05B 19/40932; G05B 2219/33099

(57) ABSTRACT

Example embodiments of the present invention are generally directed to faceted materials patterned in relation to a folding tessellation and methods of folding sheet materials into patterned structures. A method for forming a folded tessellation is provided for structural row and column input data that is to be interpreted through advanced folding algorithms to yield a versatile fabrication process for folded tessellations.

### CROSS-REFERENCE TO RELATED APPLICATION

This application claims the benefit under 35 U.S.C. § 119(e) of U.S. Provisional Patent Application No. 63/723,456, filed November 21, 2024, which is incorporated by reference herein in its entirety.

### FIELD OF THE INVENTION

Example embodiments of the present invention are generally directed to faceted materials patterned in relation to a folding tessellation and methods of folding sheet materials into patterned structures. A further embodiment is the application of the present invention to structural, architectural and acoustic panels.

### BACKGROUND OF THE INVENTION

Folded tessellations are valuable for many applications, including sound absorbing materials, architectural panels, energy absorbing materials for packaging and transportation, structural core materials, and many other applications. Folded tessellations may be fabricated from a diverse range of materials, including but not limited to papers, metals, fiber composites, felts, plastics, woven and non-woven composites, and any material that folds.

Folding is an unusual forming process in that the sheet material undergoes very little in-plane deformation. In contrast, stamping or thermoforming generally requires significant strain. Another interesting phenomenon when folding tessellations is that due to the many directions of fold crease lines the material will generally contract in the top view from both horizontal directions. Together these properties of folding present fabrication challenges that have traditionally limited the state of the art. In particular, conventional presses and dies are not suitable to fold tessellations. As such, there is a need in the art to include new cost-effective fabrication procedures for folding tessellated sheet materials.

### SUMMARY OF THE INVENTION

It is one aspect of some embodiments of the present invention to provide a method for forming a folded tessellation. In another embodiment, a method is provided for structural row and column input data to be interpreted through advanced folding algorithms and be applied to CNC (computer numerical control) operations to yield a versatile fabrication process for folded tessellations. One skilled in the art would appreciate that CNC machining is a manufacturing process in which pre-programmed computer software dictates the movement of factory tools and machinery.

In one aspect of the present invention the row and column data are entered into the algorithms to yield data that assists in the fabrication of CNC tooling, the tooling then acts on the sheet, and the sheet is then folded into a geometry substantially similar to the folded tessellation pattern of the algorithms.

In another embodiment, materials may be chosen and folded into tessellation geometries to provide, for example, architectural panels, light diffusers, acoustic panels, energy and vibration absorbing materials, structures for core materials for laminated panels and many other products.

In another embodiment perforated, permeable, or acoustic materials may be folded in a manner substantially similar to a folding tessellation pattern to enhance the acoustic

performance of the material by adding tessellation structure to the material geometry and configuration.

In yet another embodiment translucent materials may be folded substantially similar to a tessellation pattern to enhance the stiffness, diffusion, visual appeal and other qualities of the material when used with lighting systems.

Conventional technology as disclosed in U.S. Pat . No. 6,935,997 and in U.S. Pat. No. 11,319,133 B2, the contents of both which are incorporated by reference herein in their entirety, provide disclosures relating to methods for designing folding tessellation, and mathematically modeling their folding process. However, such traditional methods of fabrication have limitations and challenges that require further improvement.

Example embodiments of the present invention disclosed herein include new cost-effective fabrication procedures for folding tessellated sheet materials and benefiting treatments in the folded sheet materials that improve their folding qualities and post fabrication performance.

The disclosure set forth herein is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive.

As will be appreciated, other embodiments of the invention are possible using, alone or in combination, one or more of the features set forth above or described below. Moreover, references made herein to "the present invention" or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1A shows a drawing of a chevron folding tessellation according to an example embodiment.

FIG. 1B shows a drawing of a chevron folding tessellation similar to FIG. 1A in a partially folded state.

FIG. 1C shows a drawing of a chevron folding tessellation similar to FIG. 2B in a further folded state according to an example embodiment.

FIG. 2A shows a schematic drawing of the hex wave.

FIG. 2B shows a schematic drawing of the triangle wave.

FIG. 2C shows a schematic drawing of the square wave.

FIG. 2D shows a schematic drawing of the sawtooth wave.

FIG. 2E shows a schematic drawing of the half hex wave.

FIG. 2F shows a schematic drawing of wave with a repeating component that has four segments forming an arch in each repetition of the wave.

FIG. 2G shows schematic drawing of the cosine wave

FIG. 3A shows a schematic drawing of an arch portion of a star wave.

FIG. 3B shows a schematic drawing of a wave similar to a triangle where the concave-down vertices have amplitude that increases and then fades along a parabolic path.

FIG. 3C shows a schematic drawing of a wave similar to a sawtooth wave where each successive repeating unit begins higher on the Y-axis than the previous unit.

FIG. 3D shows a schematic drawing of a repeating wave where the repeating unit is comprised of six segments, the slopes of the segments alternate in sign similar to a triangle wave, the unit is left-right symmetric, the units maximum peak is between its third and fourth segment, the units minimum valley is between the sixth segment of a unit and the first segment of the next unit, and the wave has 180 degree rotational symmetry.

FIG. 3E shows a schematic drawing of repeating wave where the unit is comprised of seven segments, and the wave geometry has left/right symmetry, but not 180 degree rotational symmetry.

FIG. 4A shows a schematic drawing of an octagon wave.

FIG. 4B shows a schematic drawing of a hexagon wave.

FIG. 4C a schematic drawing of a star wave with 18 points.

FIG. 4D shows a schematic drawing of a square wave.

FIG. 4E shows a schematic drawing of a hexagon wave.

FIG. 5A shows a drawing of the back of a chevron folding tessellation according to an example embodiment, where the material has been cut out in a groove profile extending partially into the depth of the material along the crease lines of the pattern to assist in folding.

FIG. 5B shows a drawing of a closeup of one parallelogram tile from FIG. 5A.

FIG. 6A shows a drawing of a groove profile with flat valley floor with fillets between the floor and sloped walls.

FIG. 6B shows a drawing of a groove profile with flat valley floor without the fillets of FIG. 6A.

FIG. 6C shows a drawing of a groove profile with round valley floor.

FIG. 6D shows a drawing of a groove profile with flat valley floor that is similar to FIG. 6B but with wider valley and thicker remaining uncut web across the groove line.

FIG. 6E shows a drawing of a groove profile with flat valley floor that is similar to FIG. 6B but with walls sloped at lessor angle.

FIG. 6F shows a drawing of a groove profile where the sloped walls meet in the valley at an angle.

FIG. 7 shows a drawing of groove profiles that are similar to FIG. 6B and meet at a vertex.

FIG. 8A shows a drawing of the top of grooved sheet material similar to FIG. 5A that has been folded.

FIG. 8B shows a drawing of the bottom side of folded grooved sheet material similar to FIG. 8A.

FIG. 9 shows a photograph of a folded grooved sheet material with geometry similar to FIG. 8A.

FIG. 10A shows a drawing of a folding tessellation pattern according to an example embodiment.

FIG. 10B shows a drawing of a folding tessellation pattern similar to FIG. 10A in a folded state.

FIG. 11A shows a drawing of a folding tessellation pattern according to an example embodiment.

FIG. 11B shows a drawing of a folding tessellation pattern similar to FIG. 11A in a folded state.

FIG. 12A shows a drawing of a folding tessellation pattern according to an example embodiment.

FIG. 12B shows a drawing of a folding tessellation pattern similar to FIG. 12A in a folded state.

FIG. 12C shows an underside view of the drawing of a folding tessellation pattern in FIG. 12B.

FIG. 13A shows a drawing of a folding tessellation pattern according to an example embodiment.

FIG. 13B shows a drawing of a folding tessellation pattern similar to FIG. 13A in a folded state.

FIG. 13C shows a drawing of the back of a folding tessellation pattern similar to FIG. 13A, where the material has been cut out in a groove profile extending partially into the depth of the material along the crease lines of the pattern to assist in folding.

FIG. 14 shows a photograph of a folded grooved sheet material with unfolded geometry similar to FIG. 13C.

FIG. 15A shows a drawing of a folding tessellation pattern according to an example embodiment.

FIG. 15B shows a drawing of a folding tessellation pattern similar to FIG. 15A in a folded state.

FIG. 16A shows a drawing of a folding tessellation pattern according to an example embodiment.

FIG. 16B shows a drawing of a folding tessellation pattern similar to FIG. 16A in a folded state.

FIG. 16C shows a drawing of a folding tessellation pattern similar to FIG. 16B but with twice as many repeats in the X and Y directions.

FIG. 17A shows a schematic of a wave used as the column information to generate FIG. 16B

FIG. 17B shows a schematic of a wave used as the row information to generate FIG. 16B

FIG. 18 shows a schematic of a wave that has been used as the column information to generate FIGS. 19A, 19B, 19C, 19D, and 20.

FIG. 19A shows a drawing of a folding tessellation that is generated with column data similar to FIG. 18 and row data a selected parameterization of the triangle wave.

FIG. 19A shows a drawing of a folding tessellation that is generated with column data similar to FIG. 18 and row data a selected parameterization of the triangle wave.

FIG. 19A shows a drawing of a folding tessellation that is generated with column data similar to FIG. 18 and row data a selected parameterization of the triangle wave.

FIG. 19B shows a drawing of a folding tessellation that is generated with column data similar to FIG. 18 and row data another selected parameterization of the triangle wave.

FIG. 19C shows a drawing of a folding tessellation that is generated with column data similar to FIG. 18 and row data yet another selected parameterization of the triangle wave.

FIG. 19D shows a drawing of a folding tessellation that is generated with column data similar to FIG. 18 and row data yet another selected parameterization of the triangle wave.

FIG. 20 shows a drawing of a folding tessellation that is generated with column data similar to FIG. 18 and row data a cosine wave.

FIG. 20 shows a drawing of a folding tessellation that is generated with column data similar to FIG. 18 and row data a cosine wave.

FIG. 21A shows a schematic drawing of a cut-away view of folding tessellation that has been folded according to the groove locations in the sheet material.

FIG. 21B shows a schematic drawing of a cut-away view of folding tessellation similar to FIG. 21A where a material has been applied to the folded grooves.

FIG. 21C shows a schematic drawing of a cut-away view of folding tessellation similar to FIG. 21A where a material has been applied to the folded grooves and tiles.

FIG. 22A shows a schematic drawing of a material with a groove profile extending partially through it.

FIG. 22B shows a schematic drawing of a laminated material with a groove profile extending through the back layer but not the front layer.

FIG. 22C shows a schematic drawing of a laminated material with a groove profile similar to FIG. 22B but having wider sloped walls.

FIG. 22D shows a schematic drawing of a laminated material with a groove profile extending through the back layer and partially into front layer.

FIG. 22E shows a schematic drawing of a laminated material similar to FIG. 22D but with the valley of the groove profile rounded.

FIG. 22F shows a schematic drawing of a laminated material with a groove profile extending partially through not into front layer.

FIG. 22G shows a schematic drawing of a laminated material made from three layers of material, with a groove profile extending through the back layer but not into the middle or front layer.

FIG. 22H shows a schematic drawing of a laminated material similar to FIG. 22G, but with the front layer thinner than the middle layer.

FIG. 23 is a key for FIGS. 21A-21C and 22A-22H that gives names to the layer markings for reference in the text.

FIG. 24 shows a drawing of a folding tessellation with the chevron geometry mounted to a wall or surface with fixtures that offset the folded tessellation from the mounting surface according to an example embodiment.

FIG. 25 shows a drawing of a folding tessellation with curved surfaces and generated from row data similar to a cosine wave that is mounted to a wall or surface with fixtures that offset the folded tessellation from the mounting surface according to an example embodiment.

FIG. 26 shows a drawing of two folding tessellation generated from row data similar to a triangle wave that are positioned near each other and forming a geometrical cavity between them according to an example embodiment.

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

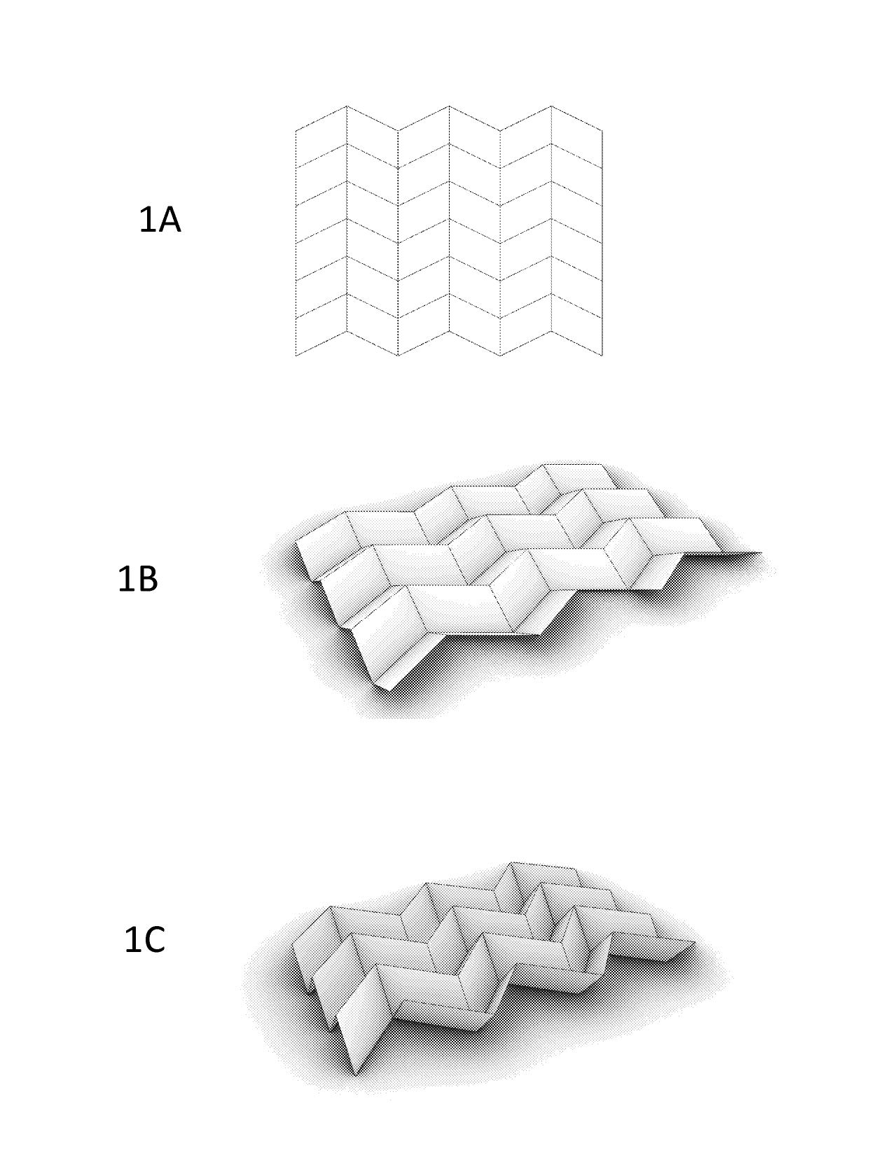

Sheet materials are naturally rolled into cones and cylinder shapes or folded along a line. These operations do not significantly stretch or deform the overall surface internal dimensions. In common folding a crease line divides the sheet into two regions by extending across the full width of the sheet. Folding tessellations give a method for imparting many short fold segments simultaneously. These segments must be laid out in a carefully calculated network for the folding process to be possible. FIGS. 1A-1C show a tessellation undergoing a folding process.

For example, in U.S. Pat . No. 6,935,997 methods are disclosed for determining three dimensional structures that are folding tessellations, their unfolded flat state, and the folding process from flat to the designed three dimensional form. For example, FIGS. 1C, 10B, 11B, 12B, 13B, 15B, 16B, 19B, 19D, 20, and 25 illustrate a few of the structures. As described in the incorporated patents, the just mentioned figures and other folded tessellations may be produced by design methods that use for input data a column wave and a row wave.

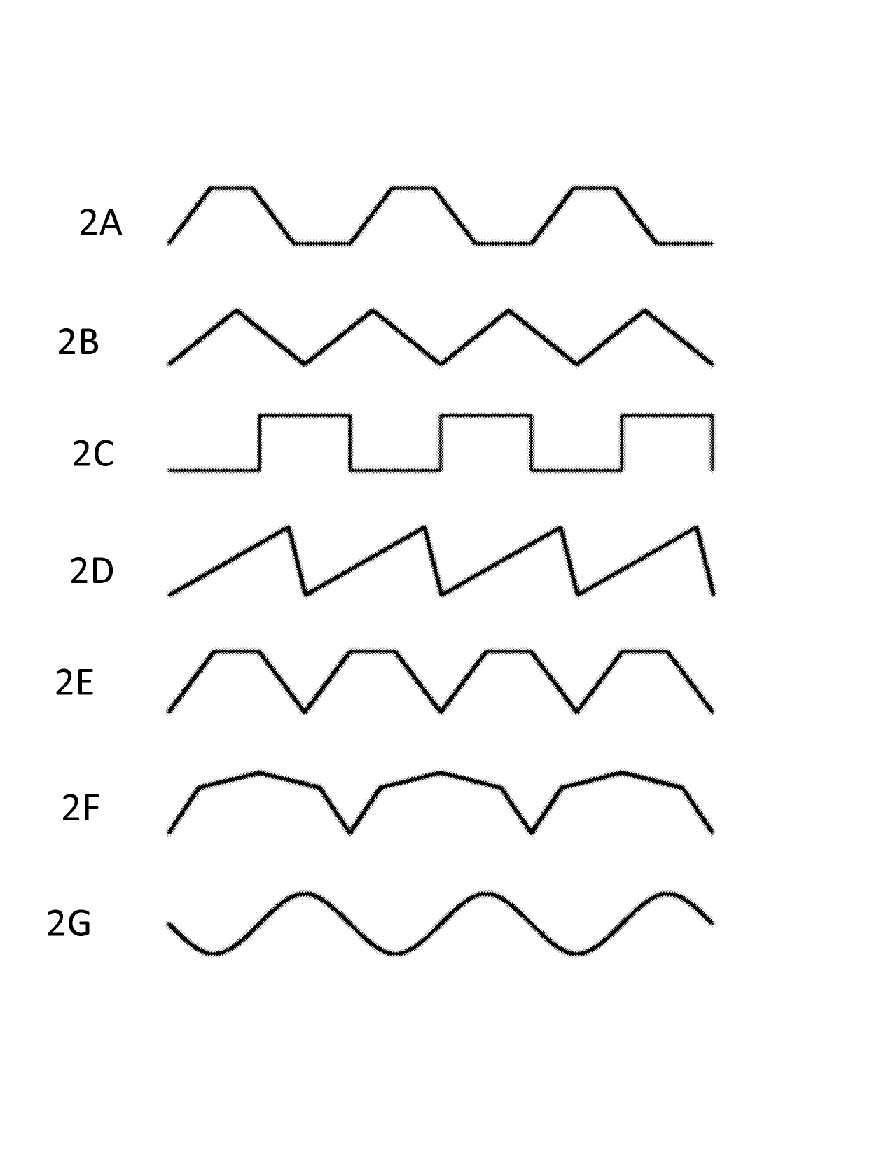

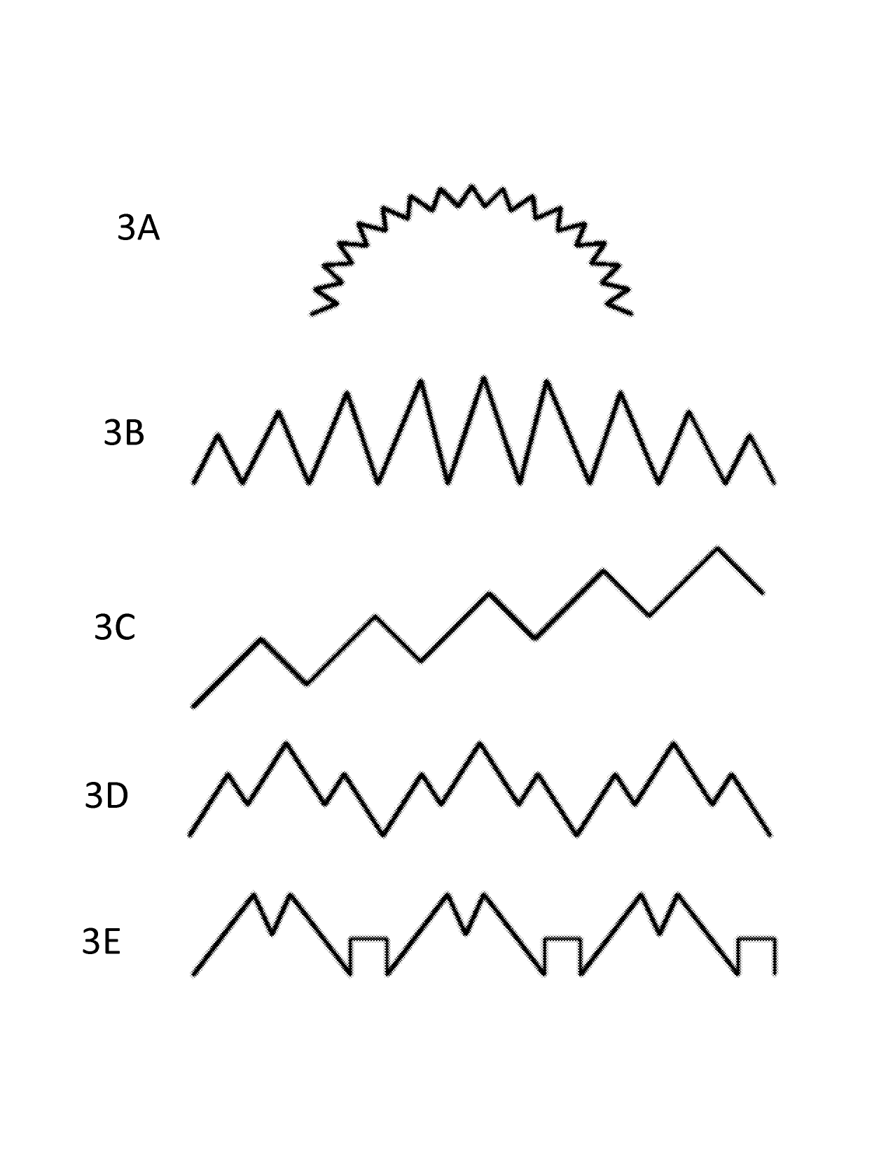

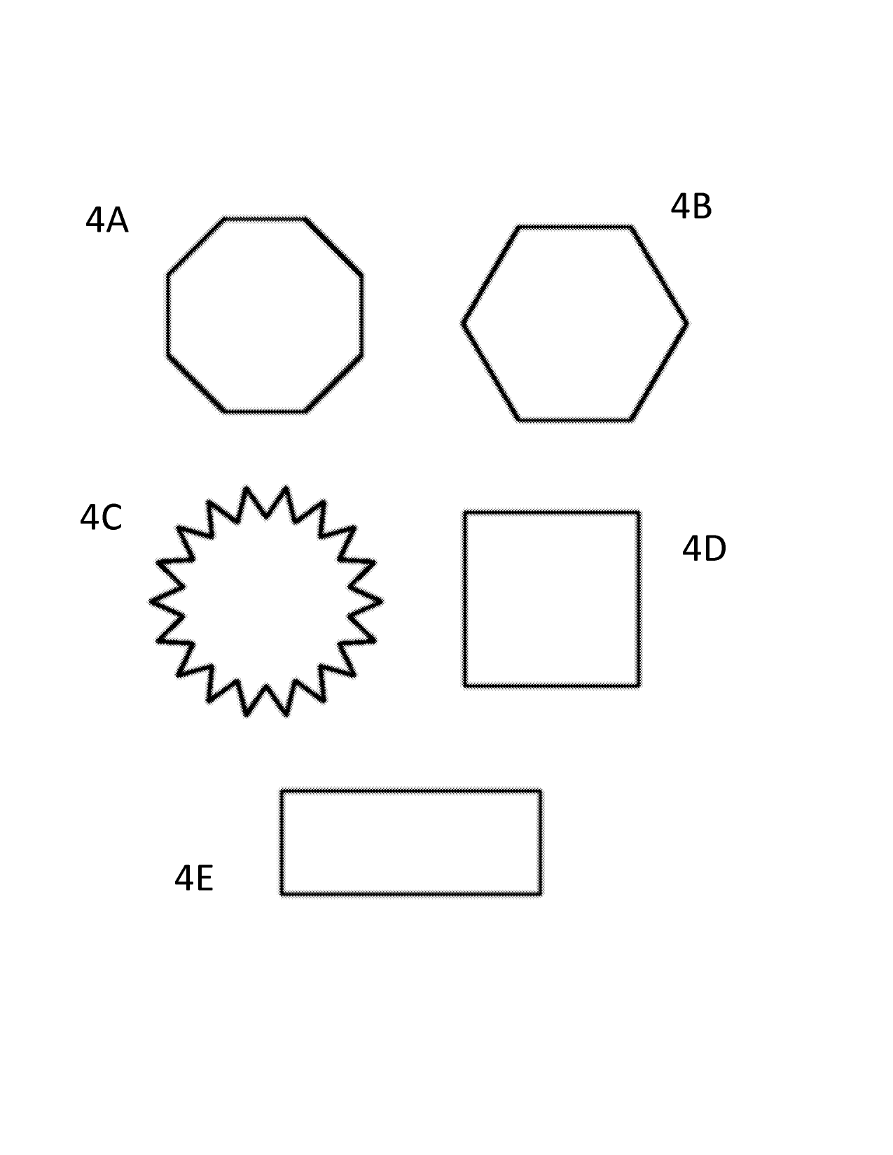

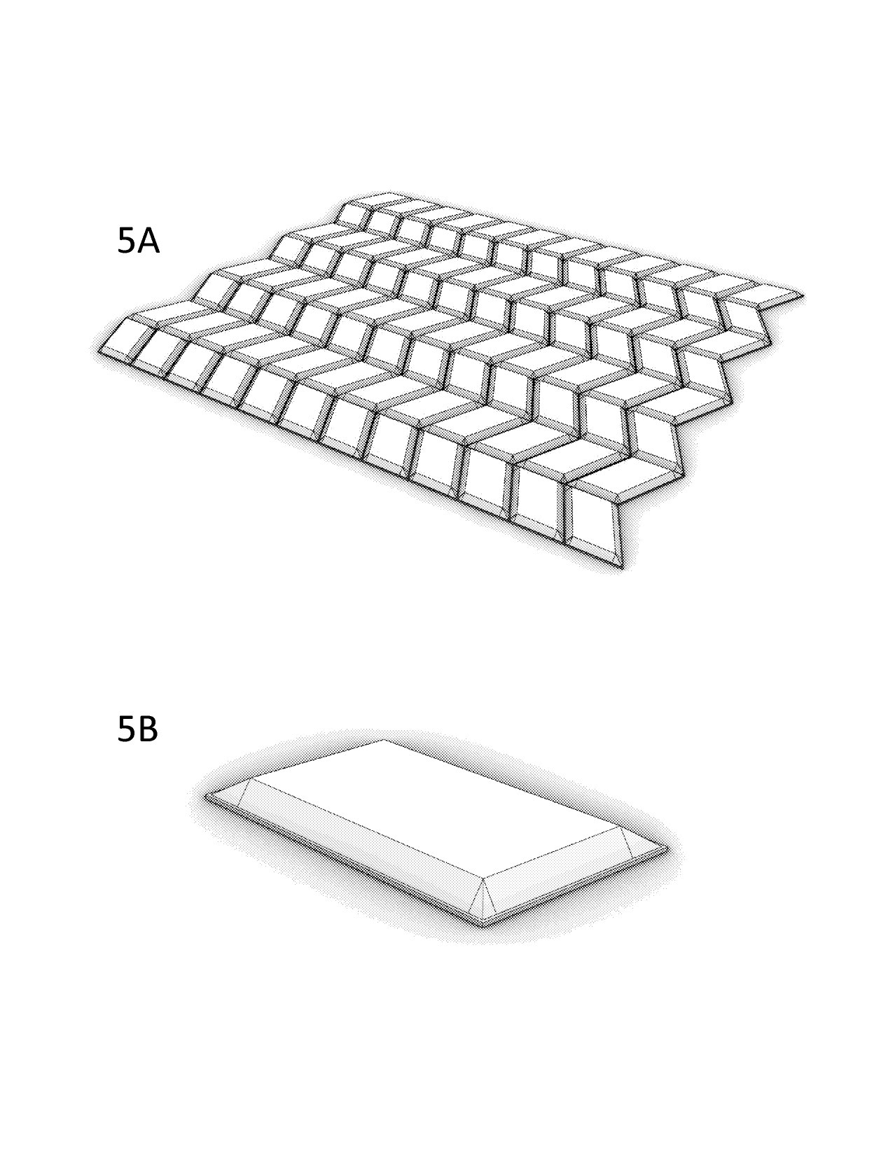

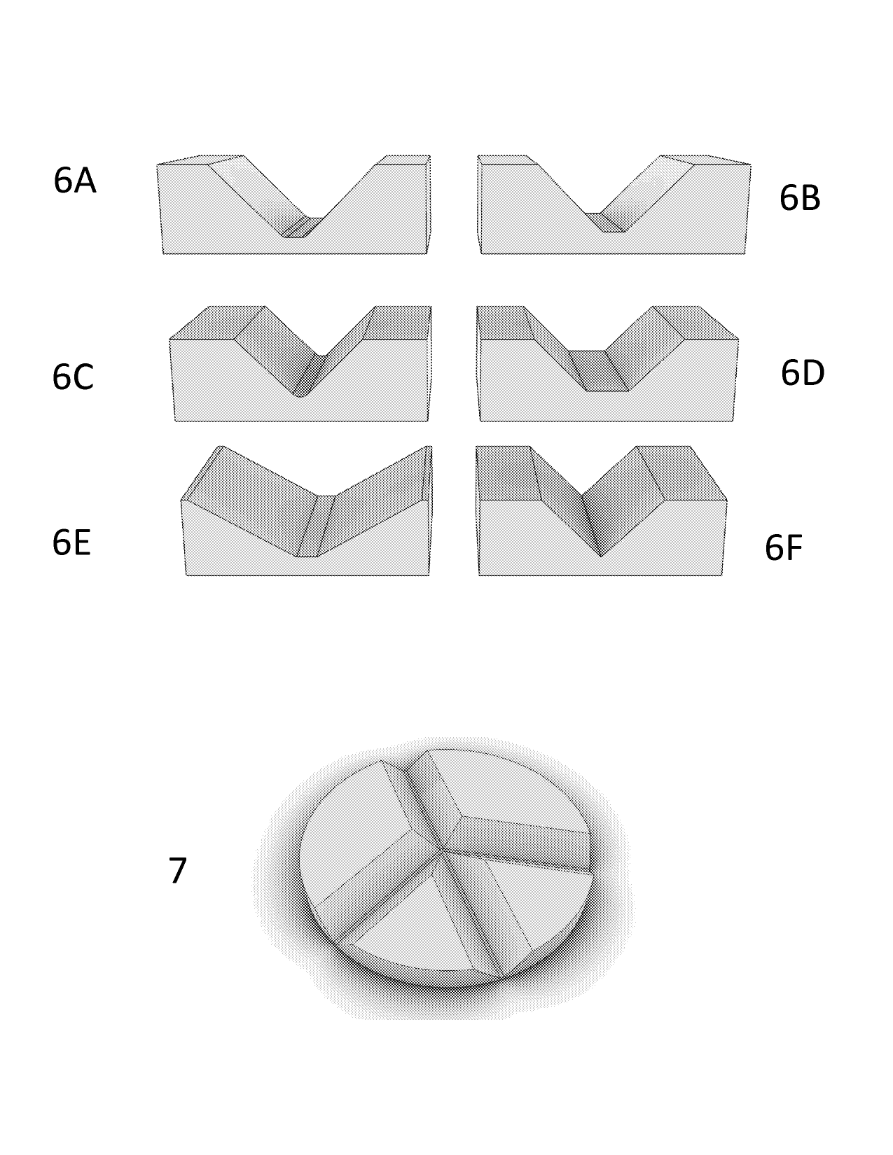

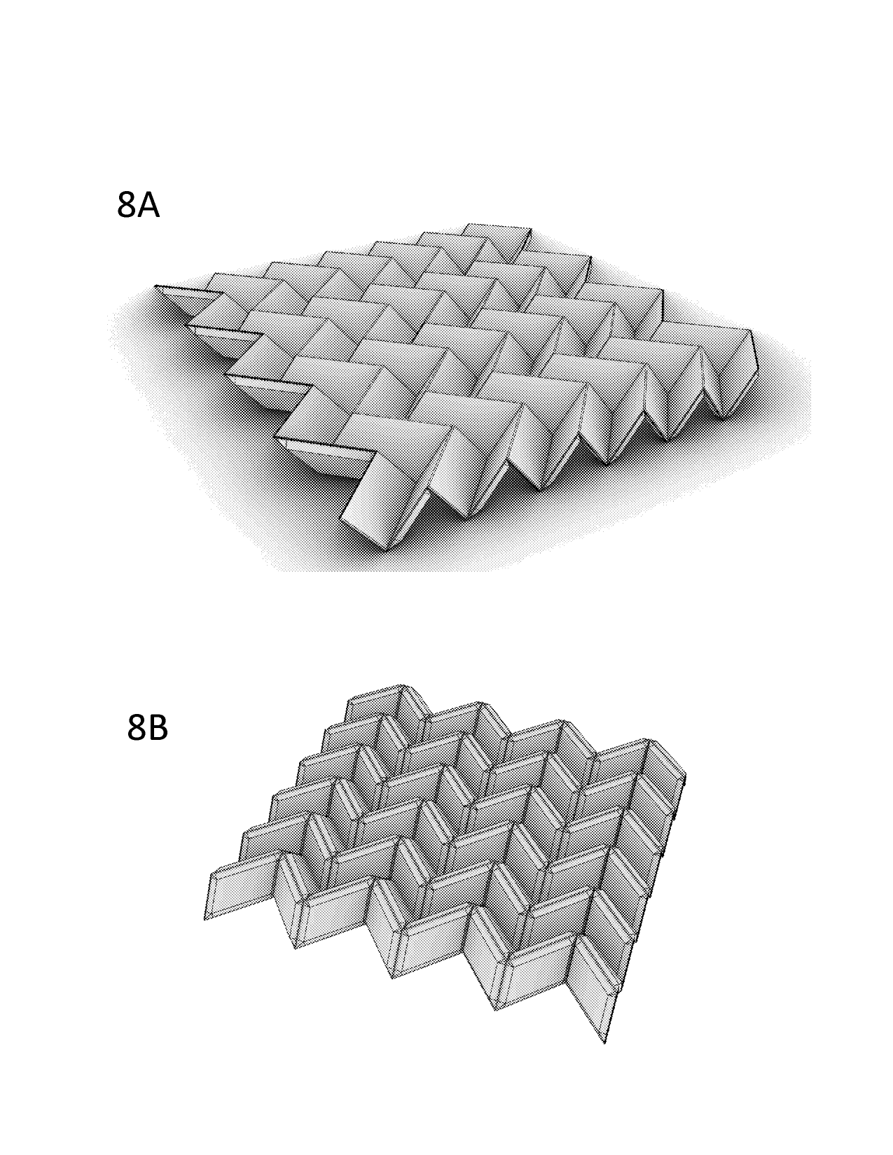

Examples of some of row waves are shown in FIGS. 2A-2G, 3B-3E, 17A, 17B, 18. Examples of some of the column waves are shown in FIGS. 2A-2F, 3A-3E, 4A-4E, 17A, 17B, 18. The waves may have symmetry or periodicity, as those shown in the figures, or they may be non-periodic. In many embodiments the waves may be specified by characterizing parameters. For example, FIG. 2B has one segment that is repeatedly reflected back along a vertical axis and so this wave type is largely given by the X-increment and the Y-increment for the segment. The axis origin and the number of repeats are additional information. The wave type in FIG. 2C is also largely given by two parameters, namely the length of the horizontal segment and the length of the vertical segment. One may note that FIG. 2D is largely given by 3 parameters, and that FIG. 3C while similar is largely given by 4 parameters, as the Y-climb of the long segment does not equal the Y-descent of the short segment. One can also use alternative values such as slope, angle, and segment length as well as other quantities for parameters. For repeating row waves, the corresponding tessellation has the same number of repeats in the X-direction. For repeating column waves, with the directional information of the next vertex augmented on each end, the corresponding tessellation has the same number of repeats in the Y-direction.

In example embodiments a sheet material substantially similar to a folded tessellation may be optimized for its acoustic or other performance characteristics. To enable this, a parameterization for the folded tessellation class is provided by the parameterizations of the input column wave a row wave. For example, if the column wave has 3 parameters, and the row wave has 2 parameters, then the tessellation class would have 5 parameters. The folding parameter from the flat to the designed state may also be useful for optimization. In example embodiments the parameterization of the folded tessellation class gives a domain over which to optimize based on the testing and performance results obtained. Since these complex structures are reduced to a few design parameters, and the change in the design parameters also yields a folding tessellation geometry, the parameterization has great value in adapting the structure for performance requirements. In an embodiment for acoustical panels, the design parameters may be optimized to reduce the environmental noise on targeted sound frequencies. In another embodiment, structural cores may be optimized for their mechanical properties such as compressive, bending, and torsional stiffnesses.

In many applications including acoustical materials, the surface wall angles play an important role in the performance of the material. Sound reflection, transmission, diffraction, diffusion, dampening, absorption and acoustic-mechanical properties are all impacted by the angle of incidence of the acoustic wave. The geometry of an acoustic chamber impacts its echoing and Hemoltz resonance as well. In one embodiment of the present invention, the design, optimization and fabrication advantages of folding tessellations are applied to acoustic sheet materials to yield a high-performance structured material that is fabricated in a cost-effective folding procedure while preserving the acoustic structural integrity of the material without imparting significant in plane strain in the material. Many acoustic materials have fibers or textures that do not survive harsh stretching or deformation. In an example embodiment this is recognized as well as the need for complex angle and facet control, and the design, algorithmic and fabrication procedures of folding tessellations applied.

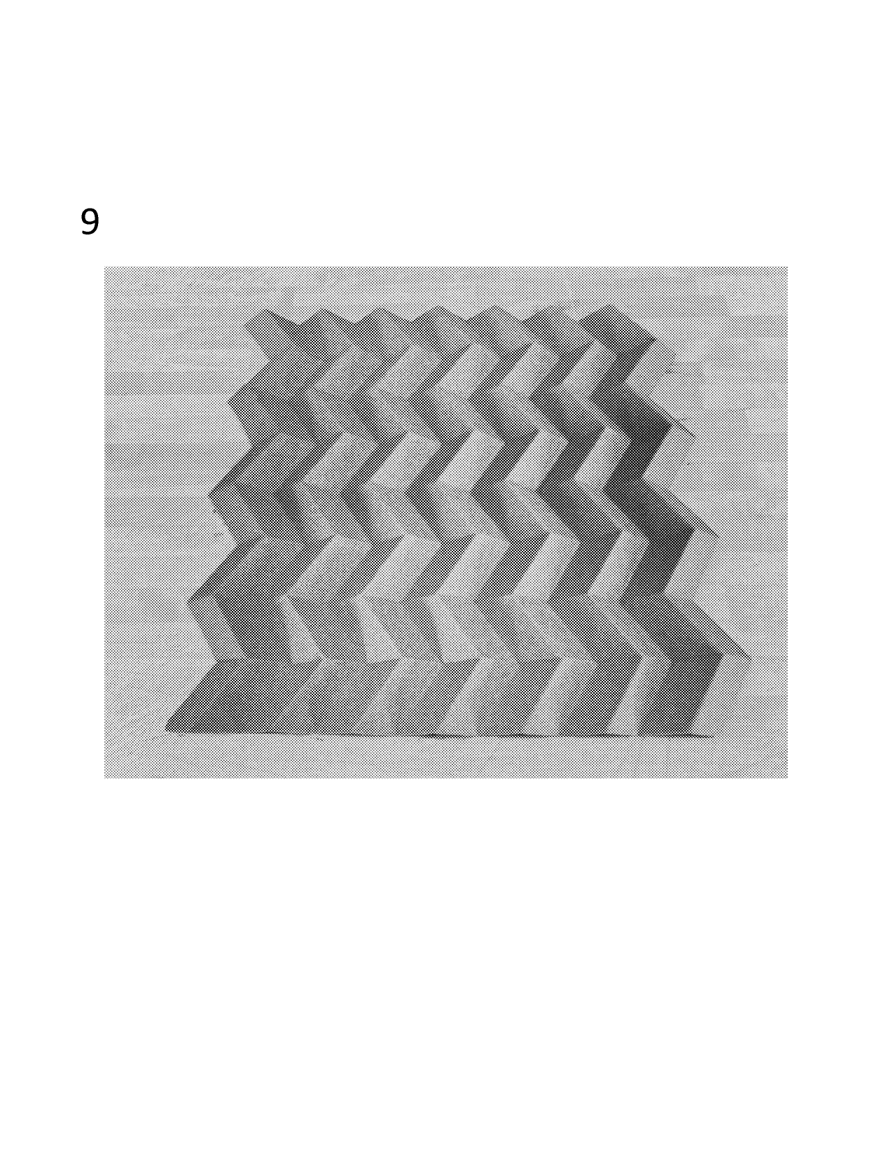

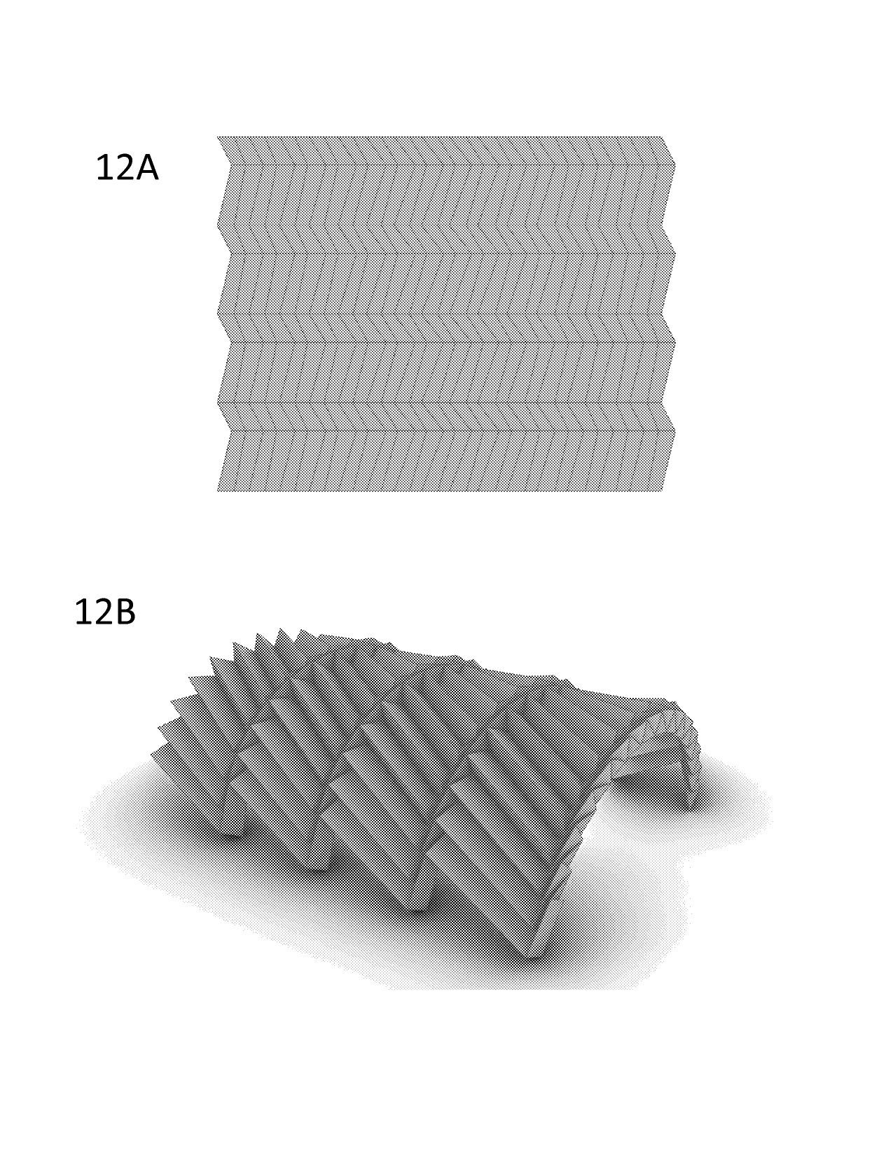

In one embodiment, sheet material may be prepared by cutting grooves in the sheet in a manner substantially similar to a folding tessellation. An aspect of this embodiment is shown in FIG. 5A, where a sheet has been prepared similar to a chevron pattern. FIG. 5B shows a section of the prepared sheet corresponding to a parallelogram or the tessellation. In an example embodiment the grooves are cut partially into the material, so that some material remains under the valley of the groove. In an example embodiment the grooves intersect substantially similar to the manner of intersection of the segments of the tessellation, with yet a further embodiment of the intersecting grooves shown in FIG. 7. The grooves may be imparted on one side of the sheet or on both sides. In a further embodiment, the remaining material under the valley substantially behaves as the web in a living hinge, enabling the sheet to fold more readily along the valley line than in the uncut material. In yet a further embodiment such as In FIG. 8A and 8B, the grooved sheet folds along its groove lines substantially similarly to the folding operation on a tessellation, and the grooves have sufficient included angle to enable the tile regions to fold without binding by collision at the fold edges. FIG. 8A and FIG. 8B are the upper and lower sides of a folded sheet after milling the grooves. FIG. 9 is yet a further embodiment of a milled chevron sheet similar to FIG. 5A.

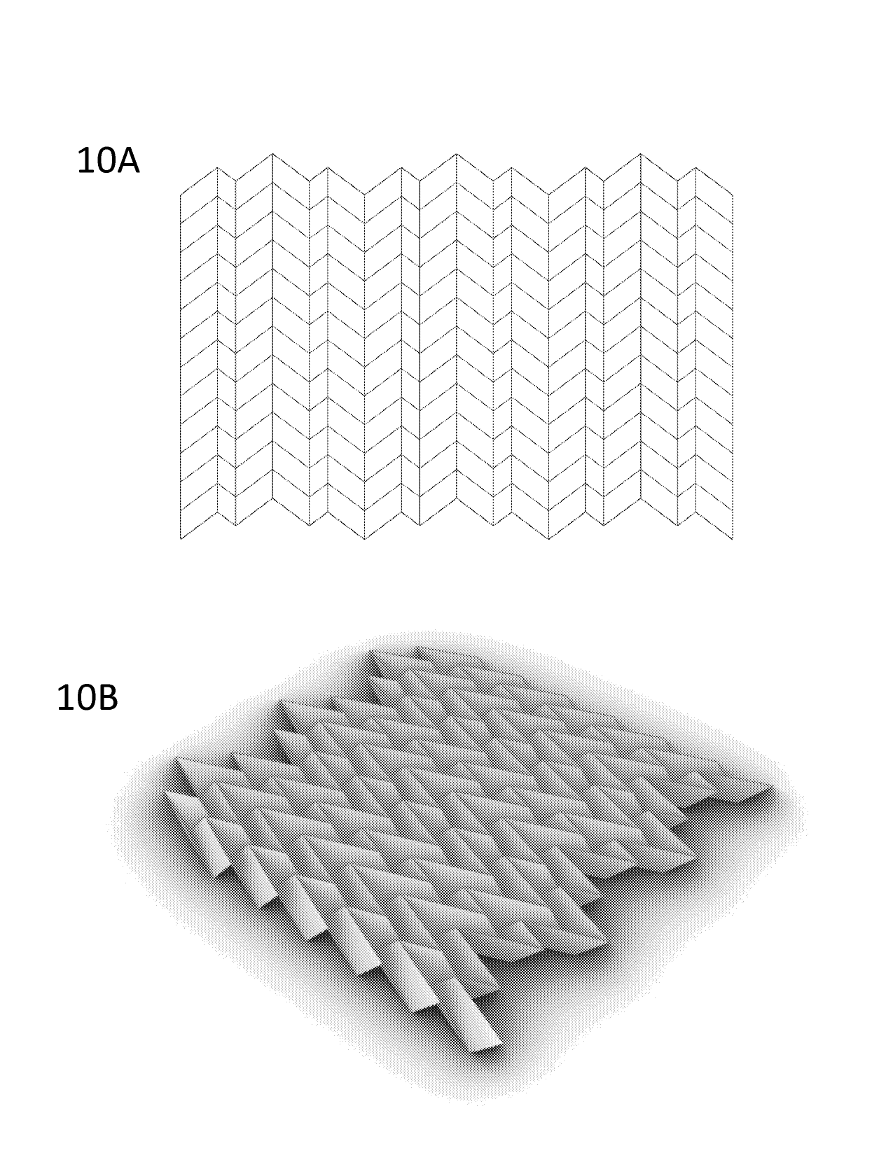

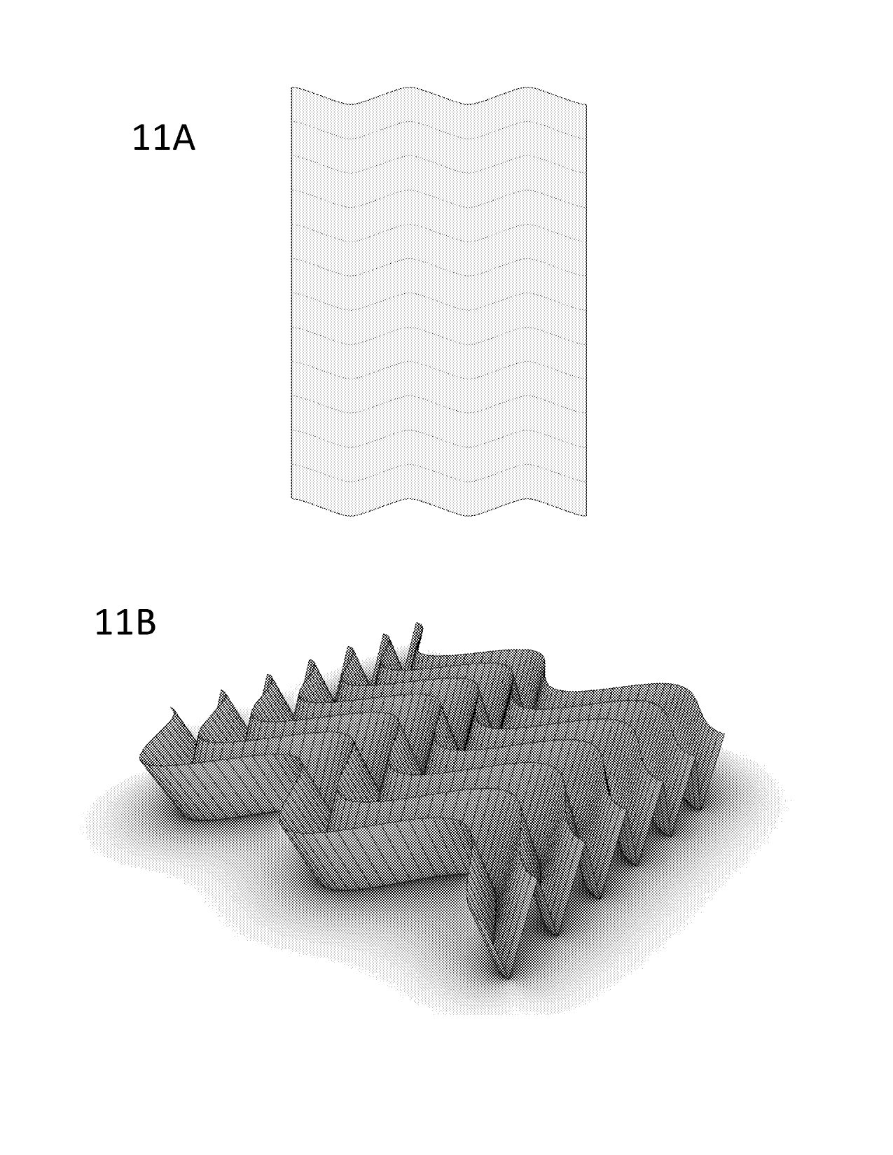

In a further embodiments, the groove profile may have a valley that meets at an angle such as FIG. 6F, a valley that meets the walls at an angle and has a flat basin such as in FIGS. 6B, 6D, 6E, a valley that is rounded such as in FIG. 6C, a valley that meets the walls with a filleted radius such as in FIG. 6A, a valley with various floor thicknesses of widths, such as FIG. 6B or FIG. 6D, walls of the valley forming an included angle of 90 degrees such as FIG. 6B, walls of the valley forming an included angle of 120 degrees such as FIG. 6E, or walls of the valley forming other included angles. In yet another embodiment other profiles may be chosen.

In yet another embodiment, chamfered tiles may be attached to a sheet to produce a surface substantially similar to a tessellation and with at least two chamfers aligning to suggest a groove geometry. This is illustrated in a yet further embodiment, where tiles such as FIG. 5B are glued to a flexible material to resemble FIG. 5A. In further embodiments the grooves may be indicated or cut with milling, routing, die cutting, a V-knife, pressing, laser cutting, water jet, or other method. In yet another embodiment, the material may be perforated along the tessellation lines, or weakened by wetting, heating or other method, to indicate the line for folding by having less bending stiffness than the unindicated material not on the lines.

It yet a further embodiment, CNC (Computer Numeric Control) devices may be driven by data with coordinates substantially effectuated by the numerical description of a folding tessellation. In yet a further embodiment, the numerical description of the folding tessellation may be provided by applying row waves and column data to the methods of U.S. Pat . No. 6,935,997. This would have advantages including the rapid design and fabrication of the prepared sheet and the ability for optimization using the wave data parameters.

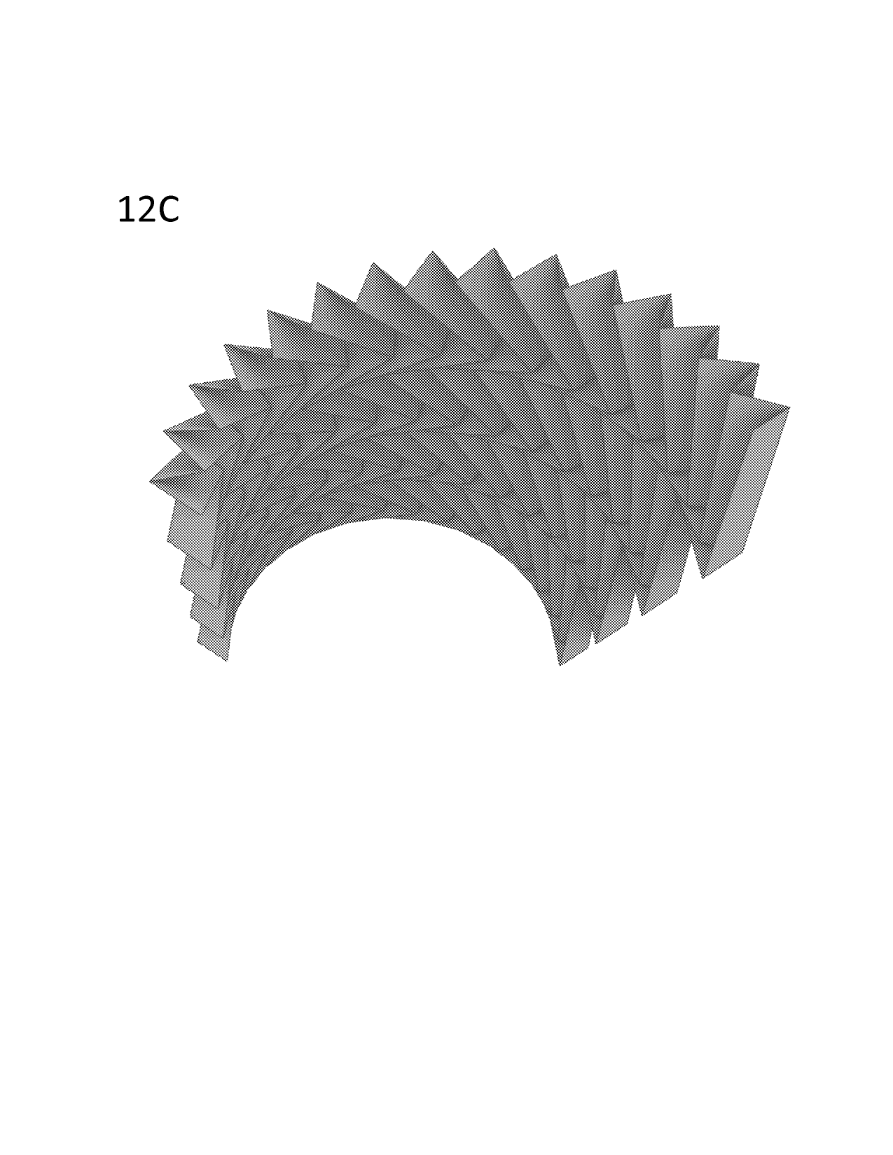

The input of row and column data is illustrated in a further embodiment, where row data substantially similar to FIG. 3D and column data substantially similar to FIG. 2B combine to express a tessellation substantially similar to FIG. 10A, which in turn after preparing the material with grooving to indicate the fold locations, may be folded to yield a structure substantially similar to FIG. 10B. One value of this pattern over the traditional chevron is the complex division of space which has structural and acoustic benefits.

The input of row and column data is illustrated in yet a further embodiment, where row data substantially similar to FIG. 2G and column data substantially similar to FIG. 2B combine to express a tessellation substantially similar to FIG. 11A, which in turn after preparing the material with grooves or other indication of the fold locations, may be folded to yield a structure substantially similar to FIG. 11B. One value of this pattern is the curved surface flex in curvature when the structure is impacted, offering broad energy absorbing properties.

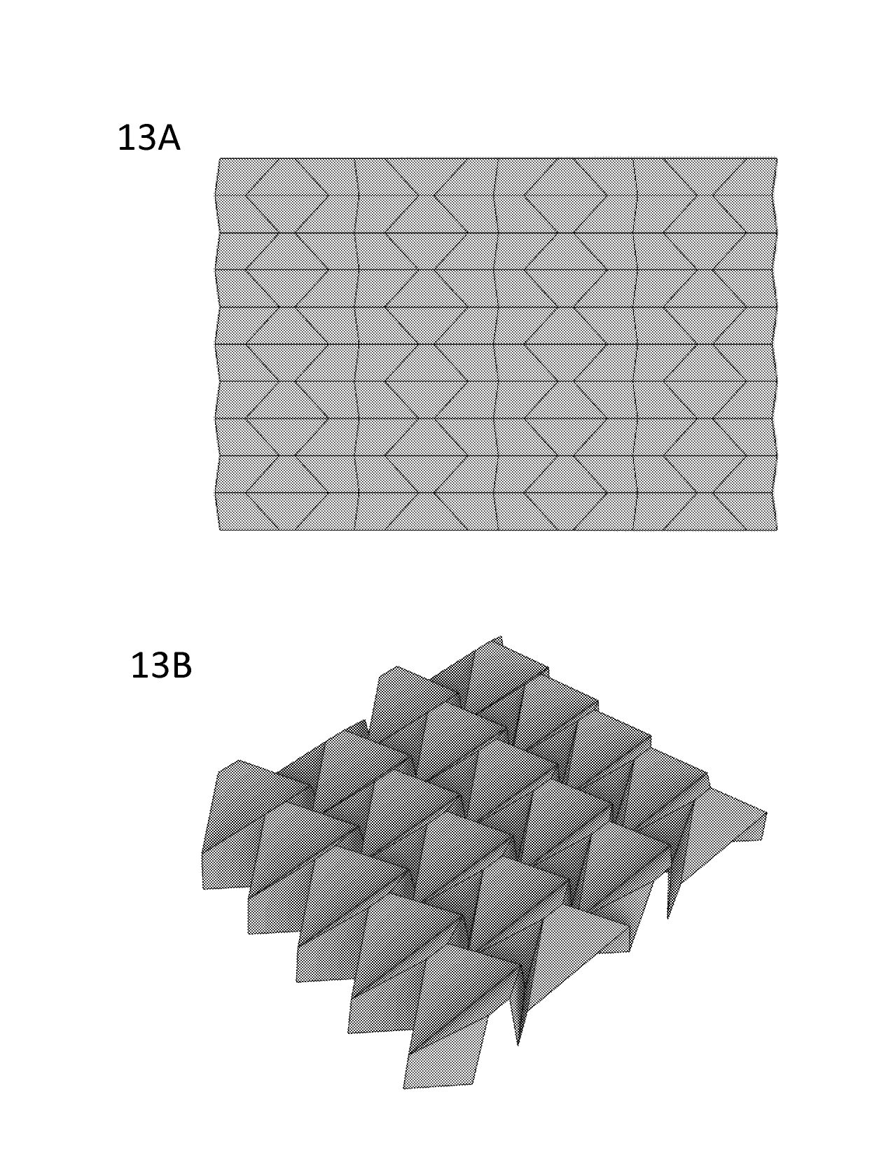

The input of row and column data is illustrated in yet a further embodiment, where row data substantially similar to FIG. 2D and column data substantially similar to FIG. 3A combine to express a tessellation substantially similar to FIG. 12A, which in turn after preparing the material grooves or other indication of the fold locations, may be folded to yield a structure substantially similar to FIG. 12B (top view) and FIG. 12C (bottom view).

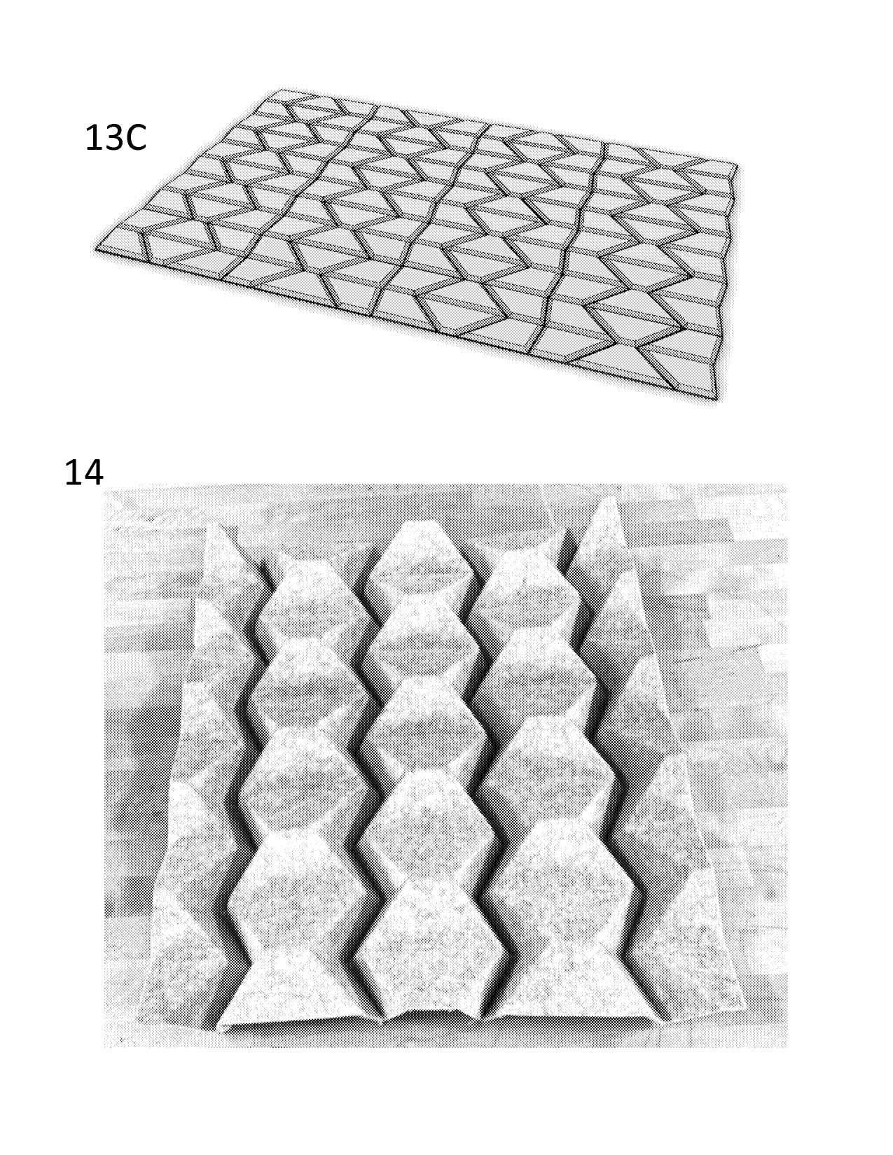

The input of row and column data is illustrated in yet a further embodiment, where row data substantially similar to FIG. 2B and column data substantially similar to FIG. 2E combine to express a tessellation substantially similar to FIG. 13A, which in turn after preparing the material with grooves or other indication of the fold locations similar to FIG. 13C, may be folded to yield a structure substantially similar to FIG. 13B. In yet a further embodiment CNC milling was applied to groove a material substantially resemble FIG. 13C, and this was then folded to yield the structure of FIG. 14.

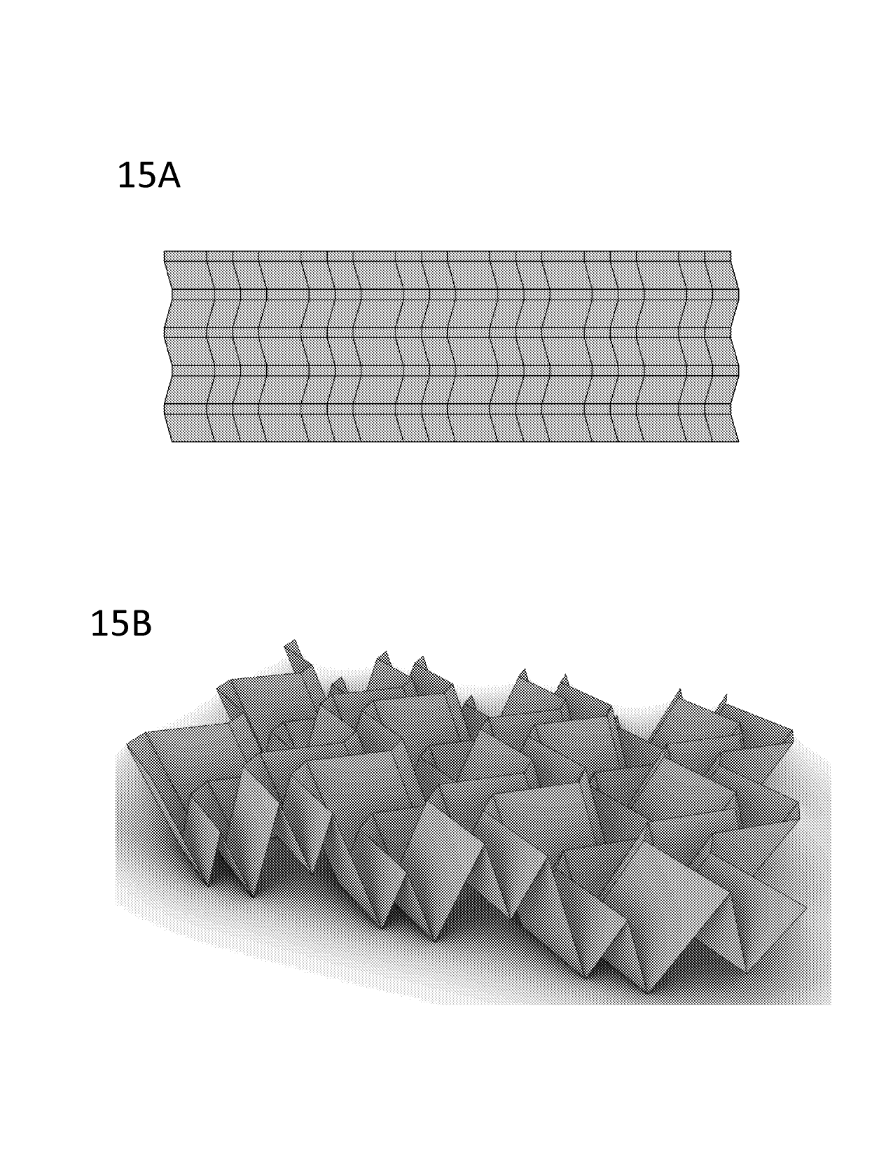

The input of row and column data is illustrated in yet a further embodiment, where row data substantially similar to FIG. 2A and column data in part similar to FIG. 3D combine to express a tessellation substantially similar to FIG. 15A, which in turn after preparing the material grooves or other indication of the fold locations may be folded to yield a structure substantially similar to FIG. 15B.

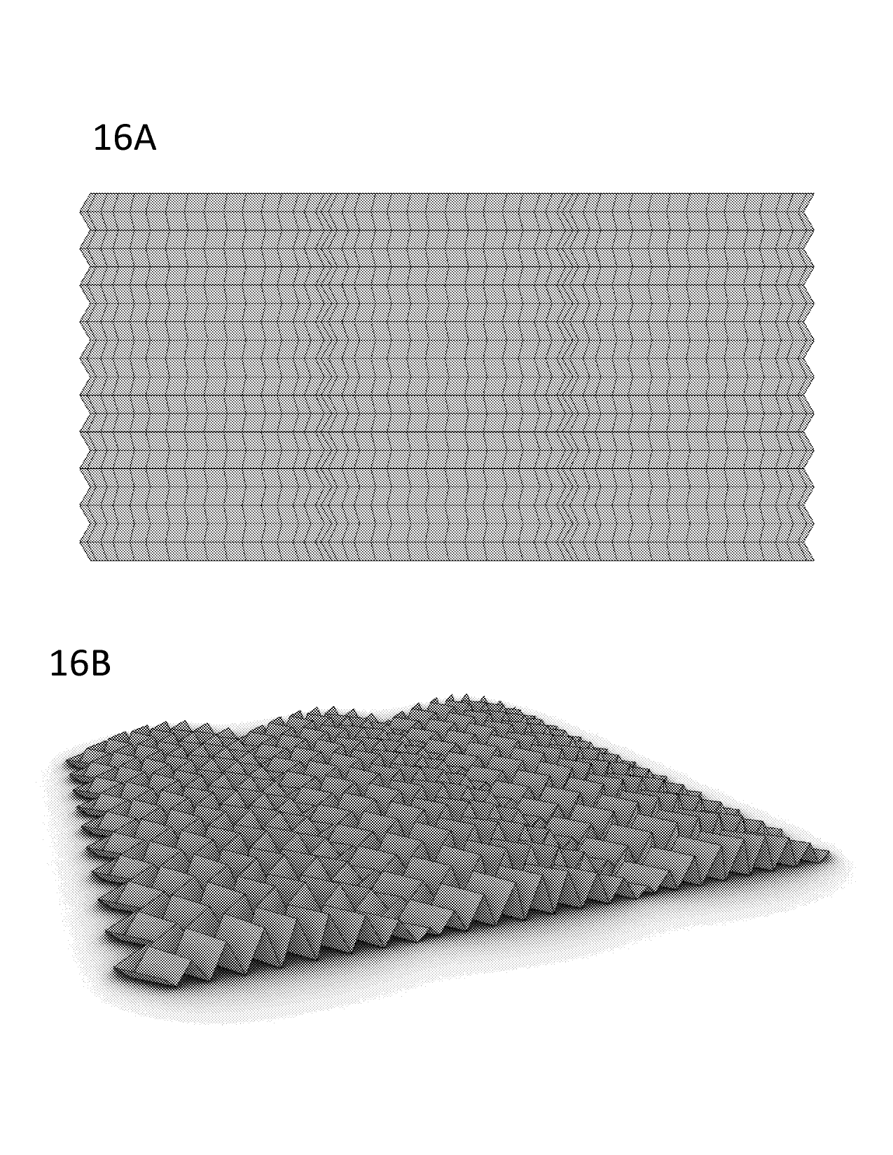

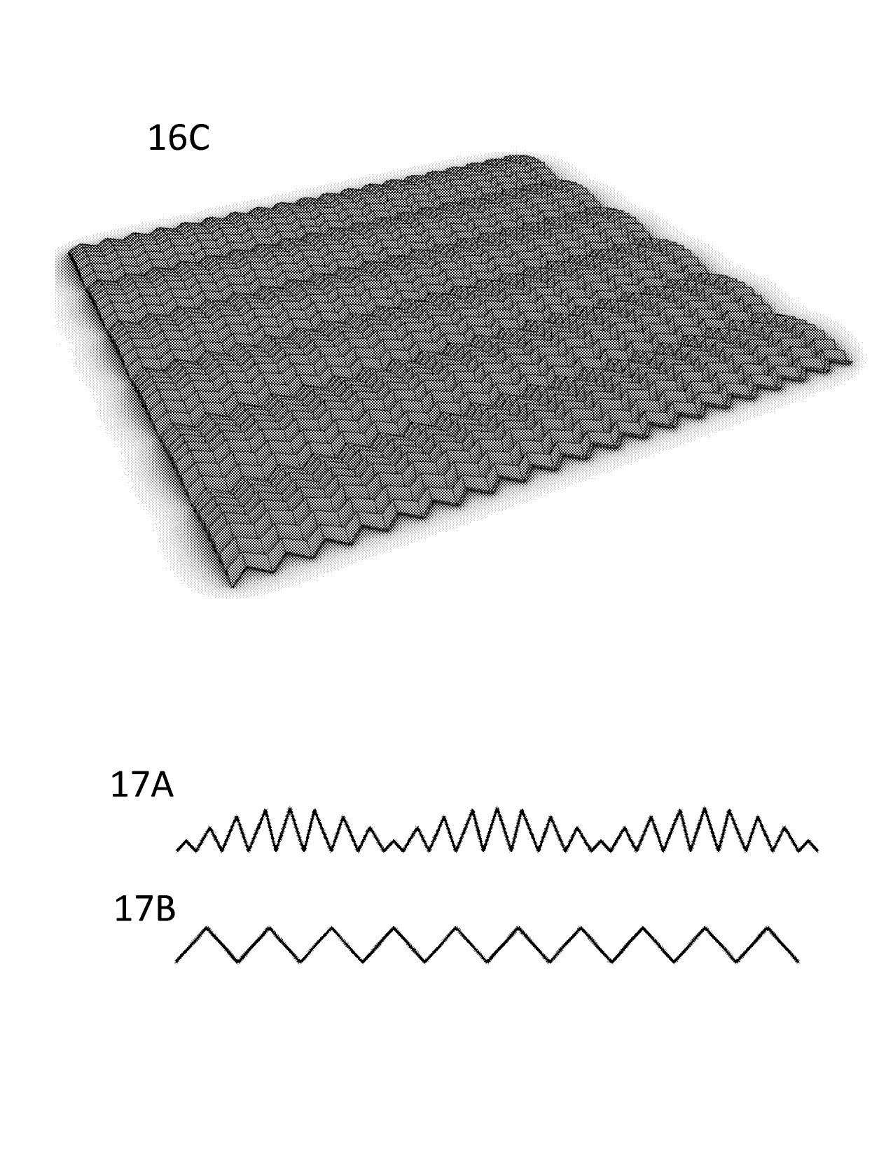

The input of row and column data is illustrated in yet a further embodiment, where row data substantially similar to FIG. 17B and column data substantially similar to FIG. 17A combine to express a tessellation substantially similar to FIG. 16A, which may be folded to yield a structure substantially similar to FIG. 16B. The multi-scale geometric effects of this pattern may have acoustical benefits. Note the folded tessellation in FIG. 16B has three repetitions as it was generated by the column wave of FIG. 17A with three repetitions, with the unfolded tessellation FIG. 16A also showing the three repetitions in the Y-direction. The undulation of this pattern may be better seen at scale in FIG. 16C where additional repetitions of the pattern unit are included.

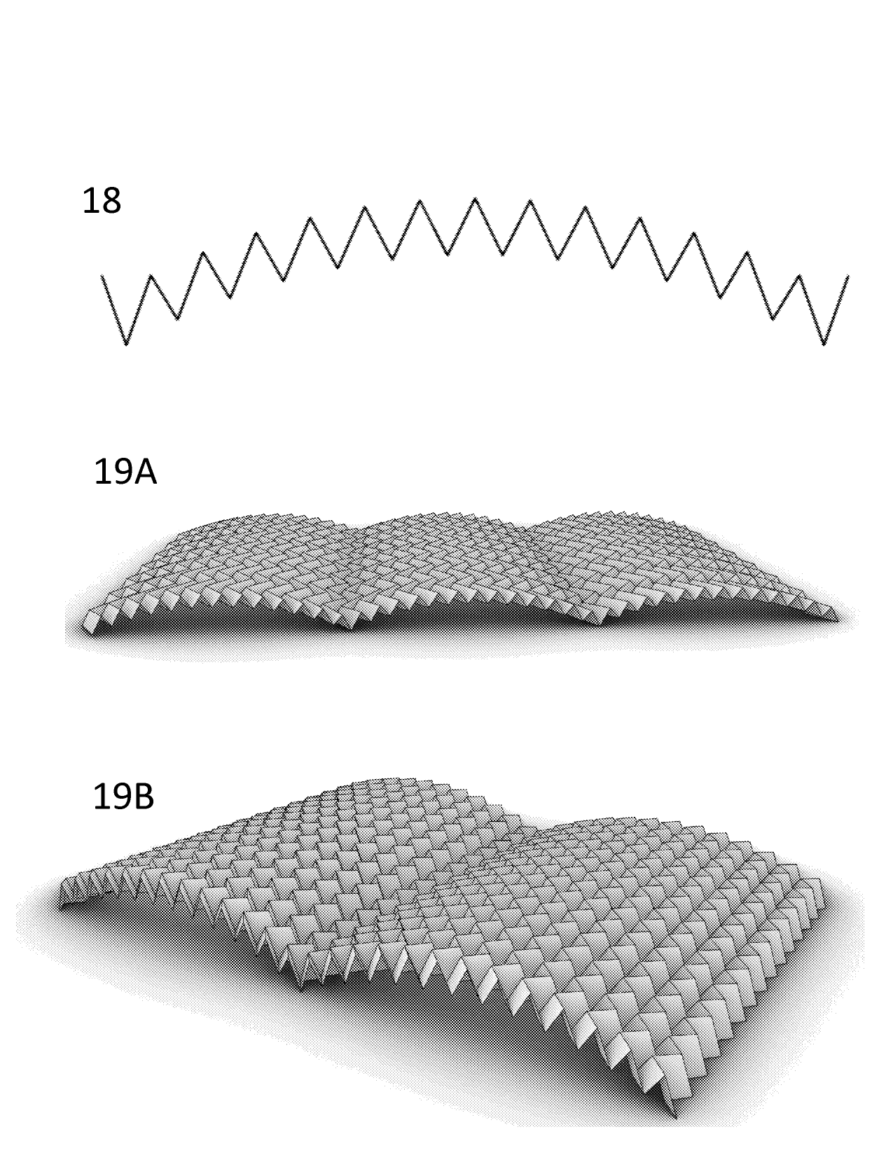

The FIG. 17A wave may be compared to the FIG. 18 wave and FIG. 2B wave. In FIG. 18 the arching effect is noticed on both the top and the bottom envelope of the wave. With input of row wave and column wave illustrated in yet a further embodiment, where row data substantially similar to FIG. 17B and column data substantially similar to FIG. 18, the inputs combine with the methods of U.S. Pat . No. 6,935,997 to express a tessellation which may be folded to yield structures substantially similar to FIGS. 19A-19D. The variation among the images is due to the relative amplitude of the row wave to the column wave. FIGS. 19D has the largest scale row wave of these figures. FIG. 19B may have the advantage of being soft and flexing readily under pressure to absorb sound waves while FIG. 19D may reflect sound waves in many directions.

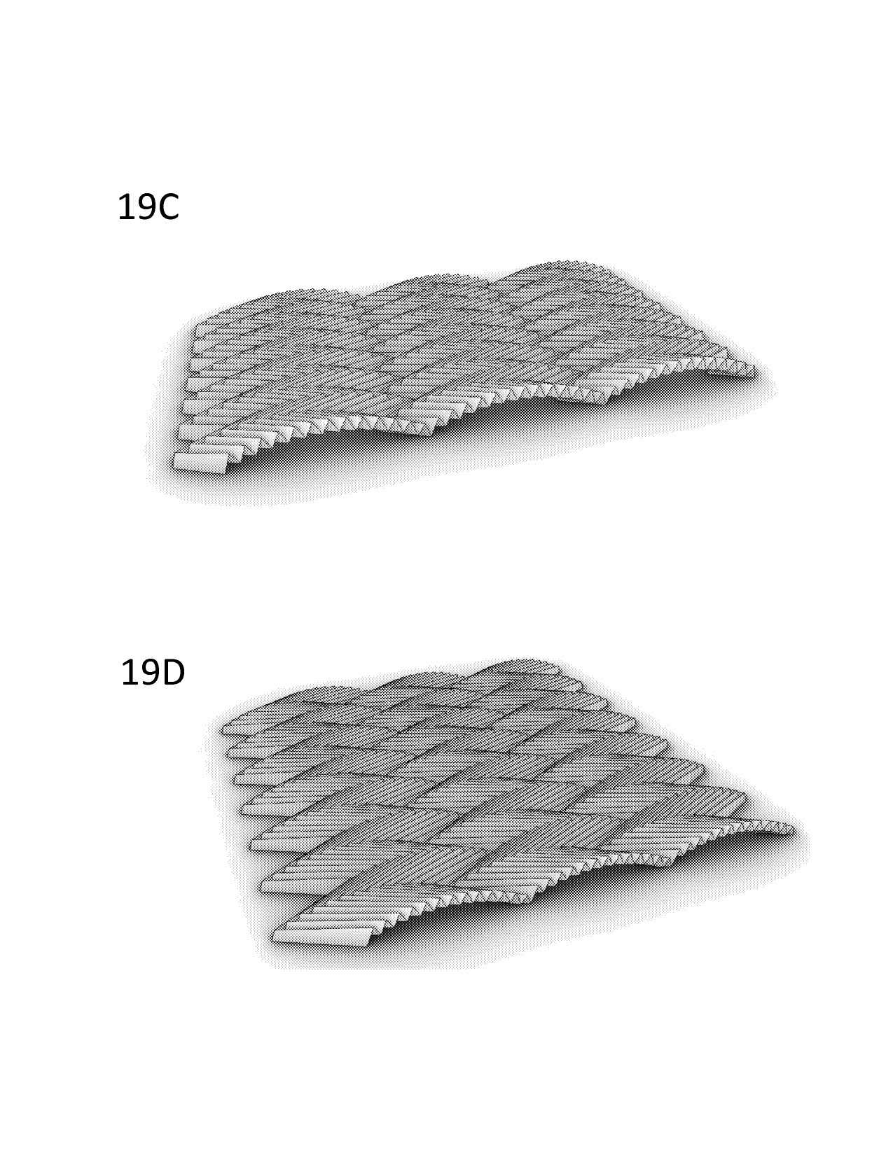

With input of row wave and column wave illustrated in yet a further embodiment, where row data substantially similar to FIG. 2G and column data substantially similar to FIG. 18, the inputs combine with the methods of U.S. Pat . No. 6,935,997 to express a tessellation which may be folded to yield a structure substantially similar to FIGS. 20. In yet a further embodiment the softness of the structure suggest it would yield easily under pressure, and any deformation of the global pattern induces a change of curvature on the curved panels, and so the structure is applied to absorb sound.

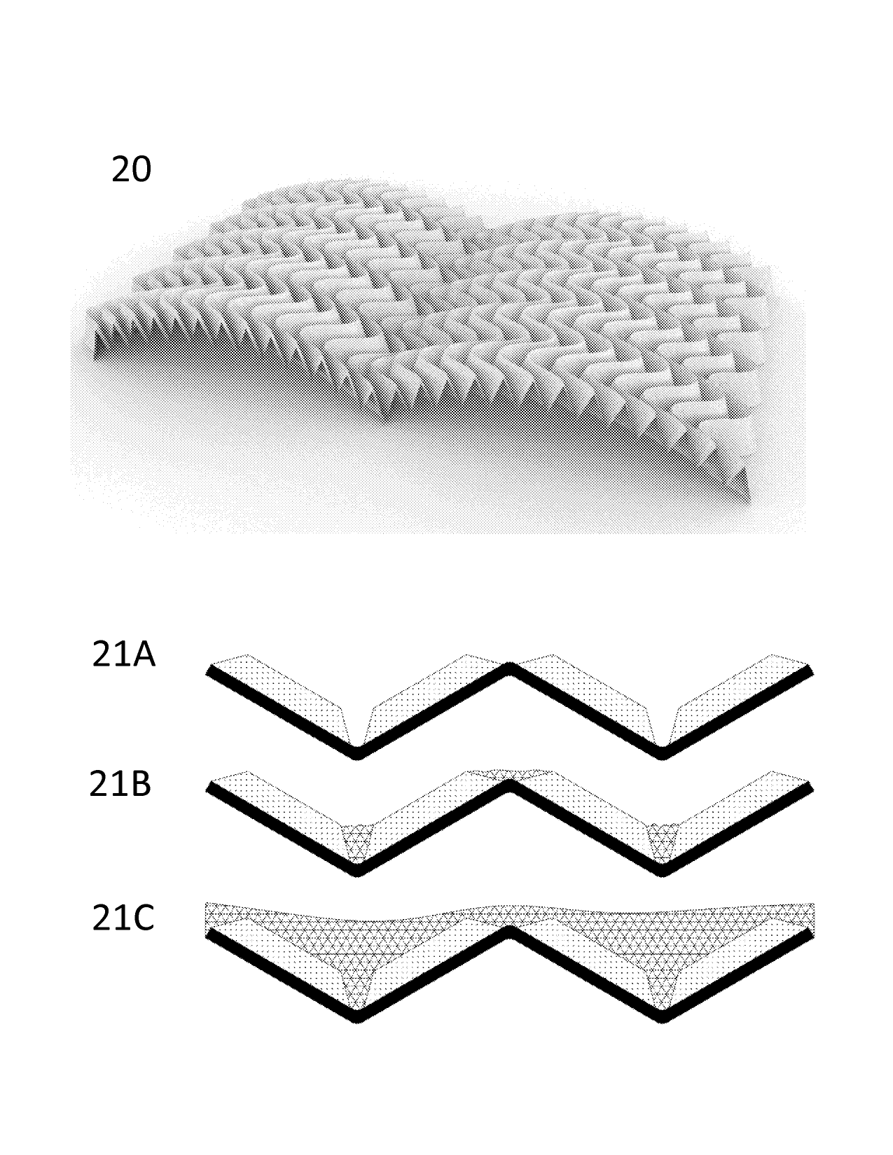

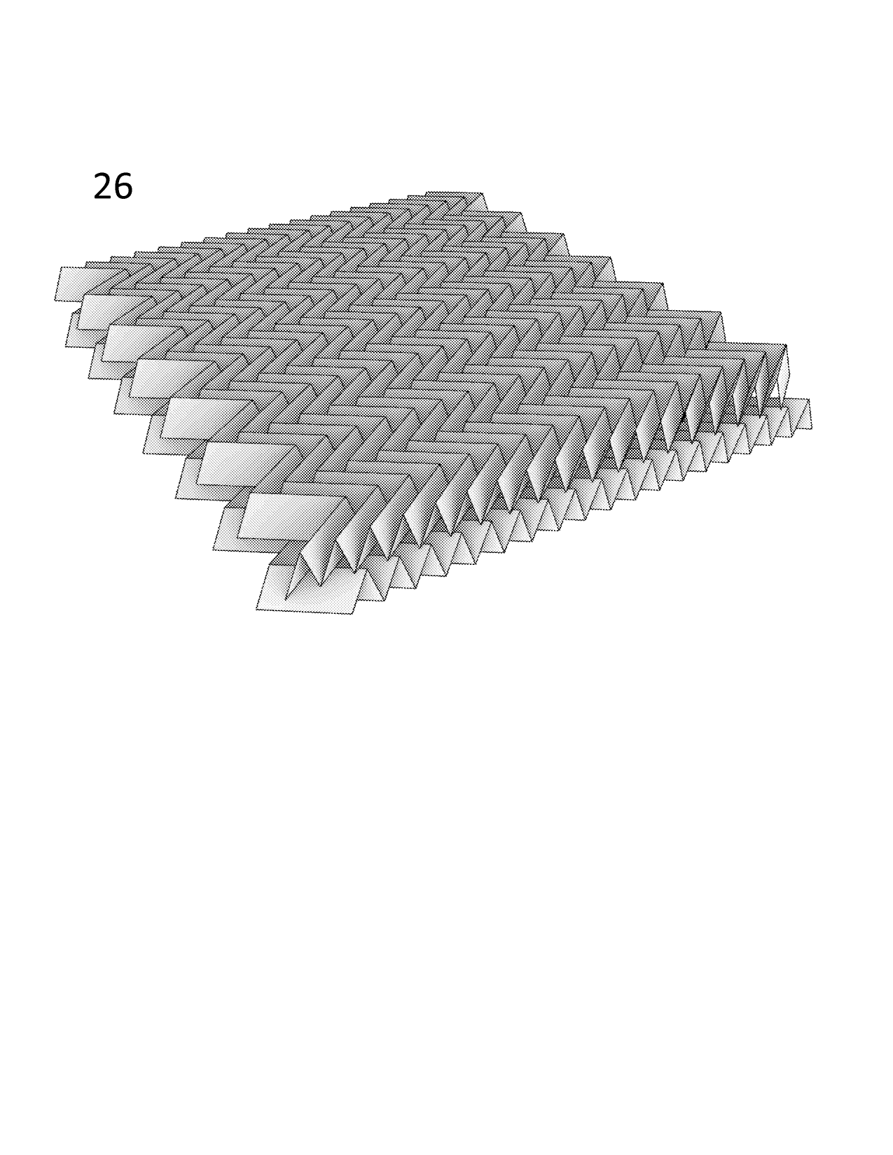

In FIGS. 21A-21C a schematic of a folded grooved sheet is shown. FIG. 23 shows names assigned to the hatch marks in these figures. In FIG. 21A the black portion and grid portion may be the same material. In an example embodiment this may represent a material that was grooved down to the depth of the grid hatching with the black thickness remaining to be a living hinge. In another example embodiment the black and grid hatching may be different materials, either glued together, grooved, and then folded or having the tiles individually chamfered such as in FIG. 5B and then attached. It is further desirable in yet another embodiment, for the black portion to act as a living hinge and moreover maintain its folded angle after folding. This is true for some metals and other materials. In yet a further embodiment the folded pattern is set in its folded state. This may be accomplished through heat treating thermoplastics and use of curing agents to set the living hinge. In another embodiment a resin or application may be applied to the grooves to fix or lock them, such as is schematically indicated in FIG. 21B where the application is shown in the triangle mesh. The resin or application may fill some of the grooves, or may span beyond the grooves such as in FIG. 21C.

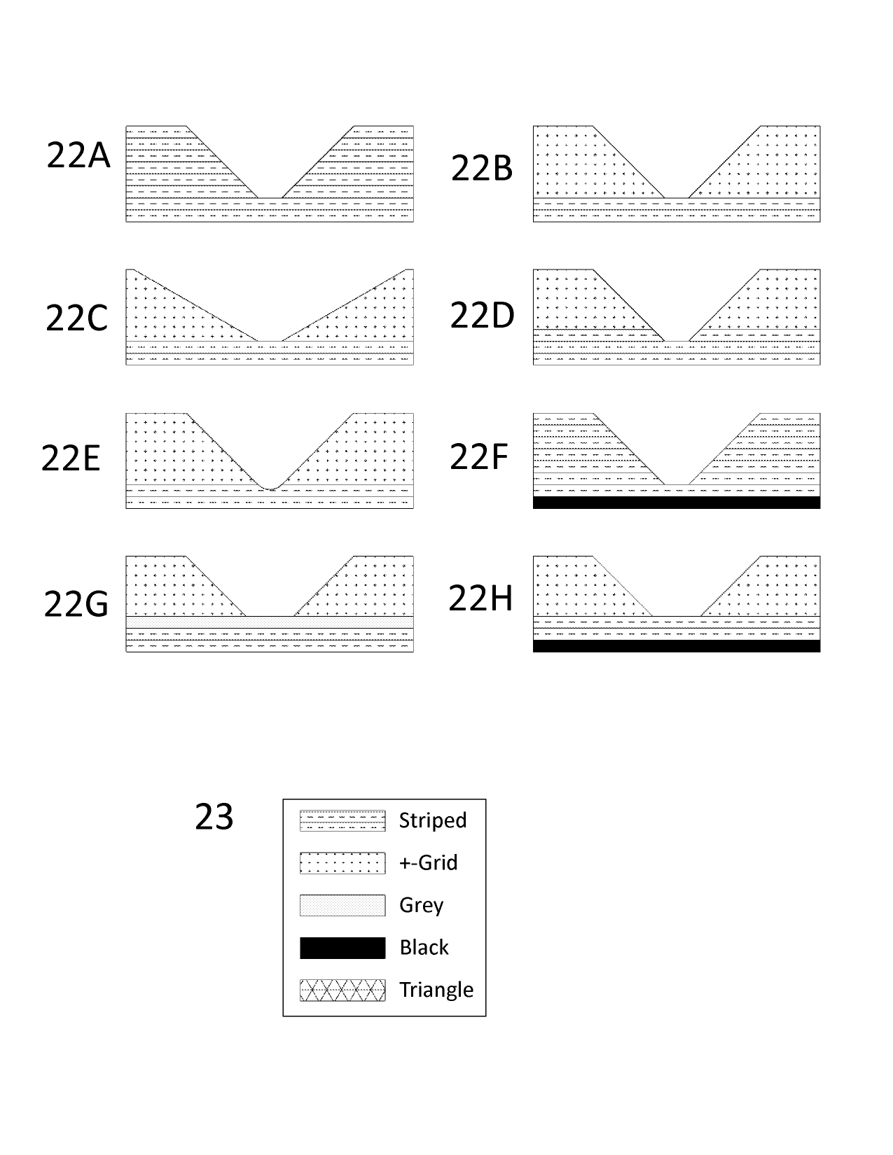

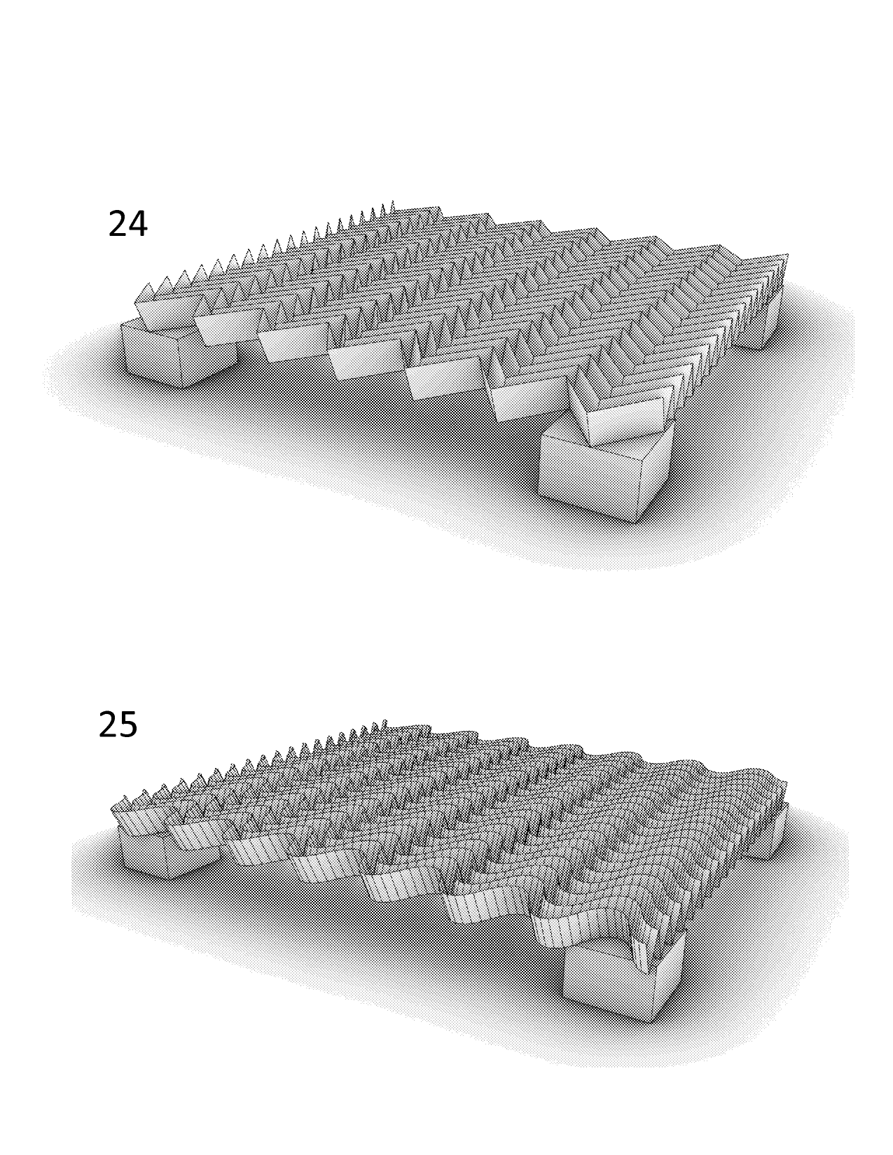

FIG. 23 is a key for the names of the hashmark regions (Striped, +Grid, Grey, Black, Triangle). In an embodiment that will be described for the schematic drawings of FIGS. 22A-22H. The Striped regions represents a bendable material, the +Grid represents a more ridged material, the Grey regions represent a vibration, energy or sound absorbing material that is also bendable, and the black regions represent a region specifically suited for the exposed surface face of a folded tessellation panel. Interchanging these roles and other choices for multilaminate material compositions that assist in the structural integrity and performance of the panel can readily be envisioned as well.

In an embodiment related to FIG. 22A, a material is grooved down to a thickness where the remaining material under the groove is strong enough to act as a living hinge and thin enough to bend easily and make a fold line.

In an embodiment related to FIG. 22F, a two-layer material composed of a top material and a bottom material is shown, the top grooved down to a thickness where its remaining material will bend, and the bottom material supplying strength, surface finish, or needed facial characteristics to the laminate. In a further embodiment the top layer is a porous stiffer material and the bottom layer is a treated cloth.

In an embodiment related to FIG. 22B and FIG. 22C, a two-layer material composed of a top material and a bottom material, has the top grooved down to just meet the bottom layer. Here the bottom layer serves as the living hinge, and the top layer provides stiffness to the facets corresponding to the tessellation polygons. In yet further embodiments the included angle of the groove profile is at least 90 degrees (FIG. 22B), at least 120 degrees (FIG. 22C), or another angle.

In an embodiment related to FIG. 22H, a three-layer material composed of a top material, middle layer and a bottom material is shown schematically, the top grooved down to just meet the middle layer. Here the middle and bottom layers serve as the living hinge, and the top layer provides stiffness to the facets corresponding to the tessellation polygons. In yet further embodiments the bottom layer may be a cloth or thin material that does not stretch easily.

In an embodiment related to FIG. 22D and FIG. 22E, a two-layer material composed of a top material and a bottom material is shown schematically, with the groove extending through the top layer and into the bottom layer. Enough material remains under the groove in the bottom layer to serve as a living hinge. In yet further embodiments the profile of the groove has a flat floor (FIG. 22D), a round floor (FIG. 22E) or other profile.

In an embodiment related to FIG. 22G, a three-layer material composed of a top material, a middle material and a bottom material is shown schematically, with the groove extending through the top layer to meet the middle layer. The bottom layer serves as a living hinge. In yet further embodiments the middle layer may have sound absorbing or sound dampening properties, or other energy absorbing characteristics. In further envisioned embodiments the folded tessellation may be inclined to locally fold and unfold due to the acoustic pressure and the middle layer may absorb energy from the minute flexing.

Numerous other variations with laminated acoustic materials are easily envisioned. These lamination strategies also apply to structural cores and light diffusers. In another embodiment, transparent and translucent materials can be laminated and grooved similar to FIGS. 22A-22H for spectacular light diffusing properties.

In another embodiment, porous boards made from thermoplastic felts are useful for their structural properties. These boards may be grooved with the remaining material webs serving as excellent living hinges. The fibrous composition has been observed to offer stiffness when thick, great flexibility and strength when thin, and additionally superior acoustic performance. In yet a further embodiment the material may be grooved, folded, and then fixtured in the folded state and heat treated. The heating relaxes the fibers in the living hinges to have the folded state as their ground state.

Acoustic panels are often mounted to the wall to soften the echo and improve the experience of the environment. In another embodiment the folded tessellation panels may be offset from the wall or mounting surface to increase the cavity behind the panel. Additionally, in yet another example embodiment the panel may comprise energy absorbing materials and the offset mounts may allow the material to flex slightly under a pressure wave. In yet another further embodiment the parameters of the folded tessellation are optimized so that the slight flexing of the material under an acoustic pressure wave is absorbed in the panel’s energy absorbing material in the desired frequency range of the application.

In an embodiment related to FIG. 24, it is desired to offset a folded chevron pattern from the mounting surface to increase the cavity behind the panel for improved acoustic effect. In an embodiment related to FIG. 25, it is desired to offset a folded tessellation having a row wave substantially similar to the cosine wave from the mounting surface to increase the cavity behind the panel for improved acoustic effect. It is yet further desired for the folded material to be an energy absorbing material. In this embodiment the flexing of the surface under an acoustic pressure wave induces a change of curvature of the surfaces and opportunity to absorb energy throughout the surface. In another embodiment an acoustic panel may be assembled from multiple folded tessellations. This may create a multi-pathway cavity between the panels with tailored acoustic effect.

In another desired embodiment, the tessellation will repeat in both X and Y directions. This assists in the manufacturing process and in producing an easily installed panel. With this embodiment, a single sheet of material may be folded into several repetitions of pattern without any assembly of parts. While other techniques such as cutting individual polygons out and assembling them may be produce multifaceted geometries, the present embodiment offers an efficient method of production as well as detailed control of the facet angle and scales in the structural architecture of the patterned material.

In another embodiment it is desirable for the folded material to take on a radial effect with a substantially cylindrical symmetry. A further embodiment of this is seen in FIGS. 12B and 12C. Column waves such as FIG. 3A, 4A-4D have cylindrical symmetry, and the corresponding folded tessellations generated with those column waves will show the same symmetry with the Two Cross Section Method. In yet a further embodiment, repeating column waves without a 180 degree rotational symmetry may be utilized to generate a folding tessellation. Examples of such waves are shown in FIGS. 2E, 2F, 3A, 3B, and 3E. As the upward facing angles and downward facing angles do not pair, the unfolded sheet will generally go through various diameter c cylindrically symmetrical forms while the tessellation is folded. In yet another embodiment it is desirable for the column wave to have 180 degree rotational symmetry. For these tessellations a repeating column wave will maintain its Y-direction repetition without going through cylindrical symmetry phases, and this assists with articulating dies and other processes for folding the tessellation during fabrication.

In another embodiment, a material indexed along its fold lines with a groove or other method to induce folding along the lines will then be folded in an articulating die. Methods for this are given in pending articulating die patents. In yet a further embodiment, the tessellation may be generated by the row wave and column wave data and the material is folded substantially according to the one-parameter folding process given by the row and column data according to the methods of U.S. Pat . No. 6,935,997. In this way the folding process may be selected by expressing the methods of the just mentioned patent.

To readily induce folding on the lines prescribed by a folding tessellation, in another embodiment the material may be structurally marked along the intended fold crease location. In yet a further embodiment, the marking is structurally weakens or softens the material so that under bending forces it will naturally fold along the marking. This may be done by removing material such as by milling or cutting a groove. It may be done by perforating the material such as by punching or laser cutting a dotted or dashed line. It may be done with a die cutter that cuts part way through the material. In some applications water or solvent may be applied along the intended fold line to soften the material providing a structural marking to localize the bending and induce a crease line. In another embodiment a laser or heat may be applied to structurally mark thermoplastic materials. In another example embodiment the structural marking corresponds to the edges of a model folding tessellation and the marking assists in inducing a folding process on the sheet that is in substantial correspondence with the fold process on the model tessellation.

In further embodiments, the materials selected may contain thermosets, thermoplastics, recycled materials, or recyclable materials. For example, in one embodiment fibered non-wovens and cloths may be folded with a resin application and cured in the folded state. Further embodiments include applying the resin to the material before folding, folding it wet, and then curing it; folding a prepreg material and then curing it; and folding the fiber material and applying the resin after folding it. Another embodiment is for thermoplastics to be folded, then heated to reset the natural position of the fibers to be in the folded state. In this way the living hinges may become relatively stiff in the desired folded configuration.

In one embodiment, the present invention provides a method for making structured or faceted material that comprises at least some or all of the following: - An articulating die;

A method for structurally indicating, milling or marking the sheet material substantially along lines similar to the edges of a folding tessellation;

A heater;

A press;

A forming tool or mold;

A post-folding forming operation in a compression mold;

A cutting process followed by a folding tessellation process;

Fibered materials;

Acoustic materials;

Light transmitting materials;

A thermoplastic material;

A thermoset material;

Laminate material;

A structural panel;

CNC operations substantially effectuated by the data from a folding tessellation;

A folding tessellation substantially expressible with row and column data;

A material milled or cut partially through with the remaining material serving as a living hinge in a folding process;

A die cutting or stamping tool;

A CNC V-knife;

Wave Data used for Row and Column information to specify a folding tessellation;

A piecewise-linear column wave;

An application of resin or a hardening mix to a material that has or will be folded;

Folding of a sheet material along a crease where the material is thinner along the crease than in neighboring regions of the material;

Parameterization of the folded tessellation class by the parametrization of the row wave and the parameterization of the column wave; and

Optimization of the performance of a folded tessellation by numerical optimization procedures on the parameters of the folded tessellation class.

Example characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate example embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A method of preparing a sheet of material, comprising: selecting a flat tessellation pattern, a CNC operation is effectuated by information from said tessellation, said CNC operation effectuates tooling that structurally marks the sheet of material along paths, the sheet is then folded along said paths, wherein a resulting folded geometry is produced in the sheet that corresponds to a folded geometry of said tessellation.

2. The method of claim 1, wherein the structural marking of the sheet comprises a groove, the groove extending part way into the depth of the material yielding a bendable region below the groove, the bendable material acting as a living hinge, and the grooved material subsequently folded along said grooves

3. The method of claim 1, wherein the folded tessellation may be substantially determined by the Two Cross-Section Method, wherein a row wave and a column wave may be used for the data in the Two Cross-Section Method.

4. The method of claim 3, wherein the preparation of the sheet of material includes a subsequent heating process applied to a folded state.

5. The method of claim 3 wherein the preparation of the sheet of material includes the curing of a resin or agent after folding of the sheet.

6. A shaped sheet of material, comprising: a tessellation pattern, the sheet is structurally marked by CNC operation effectuated by the tessellation, wherein the structurally marking is in substantial correspondence to edges of the tessellation pattern, and the sheet is then folded along said marking, wherein a resulting folded geometry is produced in the sheet that corresponds to a folded geometry of said tessellation.

7. The sheet of claim 6, wherein the structural marking of the sheet comprises a groove, the groove extending part way into the depth of the material yielding a bendable region below the groove, the bendable material acting as a living hinge, and the grooved material subsequently folded along said grooves.

8. The sheet of claim 6, wherein the folded tessellation may be substantially determined by the Two Cross-Section Method, wherein a row wave and a column wave may be used for the data in the Two Cross-Section Method.

9. The sheet of claim 8, wherein the preparation of the sheet of material includes a subsequent heating process applied to a folded state.

10. The sheet of claim 8, wherein the preparation of the sheet of material includes the curing of a resin or agent after folding of the sheet.

11. The sheet of claim 7, wherein the folded material is an architectural or acoustic panel.

12. The sheet of claim 7, wherein the material is comprised of fibers.

13. A shaped sheet of material, comprising: a tessellation pattern, the tessellation having repetition along a first axis and a second axis, information from the tessellation effectuating a structural marking of the sheet in substantial correspondence with the edges of the tessellation, and the sheet is then folded along said marking, wherein a resulting folded geometry is produced in the sheet with repetition along two axis, that corresponds to a folded geometry of said tessellation.

14. The sheet of claim 13, wherein the structural marking of the sheet comprises a groove, the groove extending part way into the depth of the material yielding a bendable region below the groove, the bendable material acting as a living hinge, and the grooved material subsequently folded along said grooves.

15. The sheet of claim 14, wherein the shaped material is used for providing sound absorption or as an acoustic panel.
